(19) United States
(12) Patent Application Publication
(10) Pub. No.: US 2007/0029914 A1
(43) Pub. Date: Feb. 8, 2007

(54) CCFL with a gaseous heat-dissipation means

(76) Inventor: Henry Yuk Ho Kwong, Hong Kong (HK)

Correspondence Address: KWONG, YUK HO HENRY, 11/F, MINERVA HOUSE, 34 LYTTELTON ROAD, MID-LEVELS, HONG KONG, HONG KONG, HK

(21) Appl. No.: 11/553,468

(22) Filed: Oct. 27, 2006

Related U.S. Application Data
(63) Continuation of application No. 11/467,653, filed on Aug. 28, 2006.

(51) Int. Cl. H01J 5/50

(52) U.S. Cl. 313/318.01

(57) ABSTRACT

A CCFL device has at least one CCFL inside a hermetically-sealed light-transmitting container that is filled with a high thermal conducitivity such as helium. A heat-conducting compound forms with the electronic driver and the lamp base into an integral ballast assembly, so that no housing for the driver is needed. The integral ballast assembly connects electrically to the electrodes of the CCFL, receives electricity through its lamp base, and uses a container connection member to connect to the light-transmitting container.

### CROSS-REFERENCE TO RELATED APPICATIONS

This application is a continuation of the U.S. patent application Ser. No. 11/467,653, filed by Henry Yuk Ho Kwong on Aug. 28, 2006

### STATEMENT REGARDING FEDERALY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention pertains generally to the low pressure mercury vapor gas discharge fluorescent devices, and more particularly to an improved cold cathode fluorescent lamp (CCFL) device comprising at least one elongated CCFL that is bent into a pre-determined shape such as a spiral, double-spiral, cone, serpentine, 1-U, 2-Us, multi-Us, and etc. Said CCFL is enclosed inside a light-transmitting container which is hermetically sealed and filled inside with a high thermal conductivity gas that has thermal conductivity better than air. Its electronic driver may also be embedded inside a heat-conductive compound comprising a synthetic material. The main features of the present invention are useful for the improved CCFL device to deliver higher intensity illumination at high electricity power input, while being in a small form factor of shape and size similar to an ordinary incandescent light bulb.

A fluorescent lamp is a low pressure mercury vapor gas discharge device, from which visible light is produced when the phosphor layer coated on the inside of a hermetically sealed tubular glass bulb is activated by the ultraviolet radiation generated by an electron flow of a mercury vapor gas discharge formed within the tubular glass bulb when a proper electricity power is applied. A plurality of electrodes are hermetically sealed into the tubular glass bulb of the fluorescent lamp for the purpose of starting and maintaining the electron flow when external electricity is applied to the electrical conducting wires linking at least one of the electrodes to the electronic driver that generates high voltage and high frequency electricity. These electrodes are designed for operating as either “hot” or “cold” cathodes, more correctly as “arc” or “glow” discharge electrodes, respectively. Fluorescent lamps having these two totally different discharge modes are commonly differentiated as the HCFL (hot cathode fluorescent lamp) and the CCFL (cold cathode fluorescent lamp), respectively. They belong to two totally different lighting technologies, because they use totally different mechanisms to generate electrons, i.e., by means of arc and grow discharges, respectively.

The HCFL operates in arc discharge mode needs a large current usually in the order of 0.1 to 1.5 ampere to heat the tungsten coils attached to the “hot” cathodes to about 800.degree.C. to 1,000.degree.C., so that the electrons from the electron emissive layer, usually in the form of alkaline earth oxides coated onto the tungsten wire, are excited and leave the electrodes to form into an arc discharge. As such, the HCFL is also known as an arc discharge lamp, or arc lamp.

The life span of the HCFL ends when the electron emissive layer is nearly evaporated by the high temperature of tungsten wire. The stress on its tungsten wire during the lamp's on-off instant is so severe that when the device is flashing continuously, or when it is turned on and off frequently, the tungsten wire breaks easily. The tungsten wire of HCFL also has a limited life as it weakens continuously by its own evaporation, same as the tungsten wire of an ordinary incandescent light bulb. These disadvantages render the HCFL a relatively short-life lighting device, with life span of usually a few thousands hours.

Another disadvantage of the HCFL is that its light output cannot be dimmed smoothly, as the tungsten wire needs a stable and high temperature to be maintained in order for it to continuously emit electrons from the electron emissive layer. The HCFL can therefore only be dimmed stepwise using complicated and expensive electronic circuitry.

The CCFL emits electrons by a totally different mechanism from that of the HCFL, by making use of a high cathode-fall voltage usually of at least 100 V between the cathodes to pull ions into the gas discharge. This commonly known “grow” discharge mechanism is driven mainly by high frequency (10 k-150 kHz) AC electricity of several hundred to a few thousand volts at start, and of 500-2,500 volts during operation. As the cathode-fall voltage needs to be high in order to obtain high efficacy and high power for general lighting purposes, the elongated lamp body of the CCFL is preferably more than one meter long.

Despite the key disadvantage of having a fragile, long and thin lamp filament, the CCFL wastes no power to heat up the electrode during the start of the lamp. There is no evaporable tungsten, so its life span can be much longer than the HCFL, usually up to 50,000 hours or more.

The CCFL can operate on a continuous flashing mode, because of its “cold” electrode is usually formed of a coiled nickel plate with a large surface area that never evaporates or weakens as the tungsten wire of the HCFL does. The CCFL starts instantly (usually less than 10 milliseconds) even under low ambient temperature, due mainly to the fact that, unlike the HCFL, it does not need to heat up the tungsten wire to at least 800.degree.C. during start, which usually takes a several hundred milliseconds. Moreover, given the high operating voltage, dimming of the light output for the CCFL can be performed smoothly and instantly by reducing the voltage either gradually or swiftly to any desirable level using an ordinary wall dimmer.

Both the HCFL and the CCFL have existed for long time, and have many different applications and a large variety of products available in the market. As such, their comparative advantages and disadvantages, as well as their completely different technical aspects, are well known to people familiar with the art. It is therefore beyond doubt that the HCFL and the CCFL are essentially totally different lamp devices, even they share the same feature in exciting the mercury vapor to generate ultraviolet radiation for the phosphor layer to emit light.

Included here for reference purposes, there are detailed descriptions of the differences between the HCFL and the CCFL in the book “Flat Panel Displays and CRTS” by Lawrence E. Tannas, Jr., (Von Nostrand Reinhold, New York, 1985), in the paper entitled “Efficiency Limits for Fluorescent Lamps and Application to LCD Backlighting,” by R. Y. Pai, (Journal of the SID, May 4, 1997, pp.71-374), and in the descriptions of prior arts contained in U.S. Pat. No. 5,834,889,granted to Ge, Nov. 10, 1998; U.S. Pat. No. 6,135,620, granted to Marsh, Oct. 24, 2000; and U.S. Pat. No. 6,515,433, granted to Ge, et al., Feb. 4, 2003.

The major advantages of the CCFL over the HCFL for the more compact size, longer life span, being dimmable, being able to flash continuously, and etc., should have long enabled the CCFL to be more widely used than the HCFL in many different lighting applications. Nevertheless, the reality is that the CCFL is so far only frequently used in the back light module for the viewing screen of note book computers, LCD TVs, flat panel displays, and for the exit signs, where the electricity power required for these applications are only several watts. The back light modules of large LCD TV screens and other large format displays need a few CCFLs operating together, but each component CCFL still operates at several watts only.

The shortcomings prohibiting the conventional CCFL devices from being widely used in lighting applications, particularly in general lighting applications for home and business uses, are explained below.

The most important shortcoming of the conventional CCFL device is that it cannot normally operate at a high electricity power input due mainly to over heating. The luminous efficacy of the CCFL decreases sharply when the body temperature of the lamp filament rises with the increase of electricity power input, particularly when the CCFL device lacks an efficient heat dissipation means.

In applications for general lighting purpose, where a bulb shaped lamp of similar size to an ordinary Incandescent light bulb is desirable, the HCFL consistently dominates the market as the preferred gas discharge device, mainly because it is usually able to operate at high power at 10-30 watt, and a non-compact HCFL such as the T12 tubular lamps is able to operate at 60 W or more.

In contrast, mainly because of the unresolved over-heating difficulty of the CCFL to operate at higher electricity power input, a CCFL in a compact form factor with a bulb-shaped container can normally operate up to 7 watt. Yet at such a lower electricity power input, the length of the CCFL is not long enough to allow the CCFL to operate with sufficiently high cathode-fall voltage, so that the ability of the CCFL to pull electrons from the “cold” cathodes are not optimized, resulting in significantly lower light output efficiency than the HCFL. In order for an improved CCFL device to be widely used for general lighting purposes, it is therefore desirable to operate it at a higher electricity power input while maintaining its compact and bulb-shaped form factor.

The HCFL normally needs more than 10 times bigger diameter tubing than that of the CCFL in order to maintain high light generation efficiency when operating at high power. This is because it operates in an arc discharge mode, where a large amount of excited electrons are generated. If the tubing diameter is too small, the mercury plasma will absorb an excessively higher proportion of the electrons, thereby weakens the mercury plasma's overall output of ultraviolet radiation, and ultimately reduces the device's light generation efficiency. For this reason, the HCFL uses tubing of usually over 10-20 mm in diameter, and of lengths normally between 6-12 cm. Glass tubes of such a configuration normally have sufficient strength on their own to withstand mechanical shocks and strong vibrations.

Unlike the HCFL, the CCFL typically works most efficiently when the inner diameter of its filament is about 0.6-1.5 mm, and for it to work at higher power, the length must be over 100 cm in order to raise the cathode-fall voltage to sufficiently high levels. As such, even the elongated and thin tabular filament is bent into a spiral or other shapes, its thin glass tubing can still be easily broken, despites the overall mechanical strength of the lamp body after bending into a spiral has improved comparing to being in a stretched-out elongated form. In order to protect the thin CCFL filament from mechanical and vibration shocks, it is therefore desirable to enclose it within a light-transmitting container, which acts both as a protecting shield, and also enables the device to look similar to an ordinary light bulb.

Due to the physical fragility of the elongated lamp filament of the CCFL, a CCFL device cannot normally be acceptable for general lighting applications in a bare lamp form factor without a light-transmitting container or a layer or coating of light-transmitting mater substantially embedding the lamp filament inside, mainly for safety reasons. Moreover, being coverless also raises another unpleasant shortcoming, as phototactic insects would be trapped and died inside the narrow pitches of the exposed lamp filament spiral.

In order to protect the thin CCFL filament from mechanical and vibration shocks, also to enable the CCFL device to look similar to an ordinary light bulb, it is therefore desirable and necessary to enclose it within a light-transmitting container, which is preferably the small glass bulb of an ordinary incandescent light bulb.

However, the CCFL filament generates considerable heat under an enclosed environment where heat is not easily dissipated. This causes the temperature within the container to rise significantly and stops the CCFL gas discharge device to function efficiently, due to the peculiar behavior of the mercury vapor as explained below.

Both the CCFL and the HCFL are low mercury vapor pressure gas discharge devices, they therefore share most of features at their post-electron generation activities. In particular, they share the same light-generating mechanism by having the mercury molecules being excited by the electrons to a higher energy state, from which they return to the ground state and produce ultraviolet radiation. The ultraviolet radiation is absorbed by the phosphor layer on the CCFL filament wall, and is finally converted into visible light and heat. During the ultraviolet radiation generation phase, the mercury gas discharge works efficiently (i.e., generates the optimum amount of ultraviolet energy) only when the coolest spot of the CCFL is within a temperature range of about 25-75.degree.C. Above this temperature range, the excessive heat will cause the mercury ions to become overly active so that the mercury vapor pressure within the CCFL increases.

As explained in a pioneer research titled “Amalgams for fluorescent lamps”, by Bloem, et al., published in the Philips Technical Review (Volume 38, 83-88 1978/79 No. 3), the mercury vapor pressure is an important parameter for a low pressure mercury discharge device, and it is usually determined by the coolest part on the wall of the lamp. If this pressure is too low, few mercury molecules are excited, meaning insufficient ultraviolet radiation falls on the phosphor layer. If it is too high, the mercury molecules absorb much of their own radiation and more of them become in excited states, and there becomes a greater probability of interactions involving non-radiative transfer of their excitation energy, so less ultraviolet energy lands on the phosphor layer.

On page 23 of the book “Electric discharge lamp” by J F Waymouth (MIT Press Cambridge Mass. 1971), it is told that the optimum mercury vapor pressure is approximately 6×10.sup.−3 torr, a value reached when the coolest spot on the wall of the lamp is about 40. deg.C. Nevertheless, with mercury vapor pressure at between about 3×10.sup.−3 torr and 9×10. sup.-3, the lamp's light output efficiency is still within an acceptable level that is not too noticeably different from the optimal light output level at mercury vapor pressure of about 6×10.sup.−3 torr.

As the light output efficiency of a CCFL device is largely dependent upon the coolest lamp wall temperature that should be kept at about 25-75.degree.C., it is therefore desirable to provide an improved CCFL device that has highly efficient heat-dissipation means, allowing the coolest lamp wall temperature of the device be kept at said optimal range when it is operating at high electricity power input.

The present invention provides an efficient heat-dissipation means by filling the light-transmitting container of an improved CCFL device with a high thermal conductivity gas such as the helium gas, which has superior thermal conductivity compared with air. As illustrated in FIG. 1 and explained in the section “Detail Descriptions of the Invention”, total luminous output of the same CCFL device increases by about 30% when air inside its light-transmitting container is replaced by the helium gas.

One more shortcoming of the CCFL is that the electronic driver has a high-voltage transformer which is highly vulnerable to heat damages. For a conventional CCFL device, the heat dissipated by the CCFL filament always cause the electronic driver to fail as the latter usually connects to the CCFL electrodes at a short distance. For example, a conventional CCFL powered at 8-13 watt enclosed within a light-transmitting container lacking an effective heat-dissipation means would have a temperature of 90-120.degree.C. for the space surrounded by the CCFL spiral. Such excessive heat generated by the CCFL, together with the heat generated by the components of electronic driver, if not being properly dissipated, affects the life span of the electronic driver adversely.

Unlike the HCFL, the electronic driver of the CCFL is more vulnerable to damages by overheating because it comprises a high-voltage transformer in its circuitry that generates about 500-2,500 volt of AC electricity at a frequency of 10k-150 kHz. This transformer, because of the limited space available for the electronic driver, is usually of a small form factor, therefore must use very thin copper wire usually of diameter less than 0.1 mm wrapping a few hundred to over a thousand turns around a small bobbin. Because of the high voltage, this transformer needs extra insulation and effective heat dissipation means, otherwise it fails easily and destroys the entire electronic driver. As the life span of a CCFL filament itself normally exceeds 50,000 hours, it is therefore highly desirable to provide an improved CCFL gas discharge device that has an efficient heat-dissipation means for the electronic driver.

Conventional electronic driver design for the CCFL is to attach all electronic components on either one or both sides of a printed circuit board, which is then disposed inside a plastic housing attached between the light-transmitting container and the lamp base. As such, plentiful space is left unoccupied within the housing and the lamp base. Owing to the bulkiness of such conventional design, it needs a large plastic driver housing, which becomes even larger because of the housing itself has a wall thickness of at least 1.5 mm on its entire circumference.

Another disadvantage of the conventional CCFL device that uses a driver housing to connect to both the light-transmitting and the lamp base is that the driver housing can not be made of metal, as it will be electrically conductive after attached to the lamp base. However, a plastic or ceramic driver housing is a poor heat conductor, especially when air is trapped inside its unoccupied space. This causes the electronic driver inside to be easily over-heated. It is therefore desirable to eliminate the housing for the electronic driver and at the same time still enabling the device to have a rigid structure and to keep the electronic driver safely and insulated.

Finally, there are wide applications of the HCFL plug-in lamps with G23 G24 or G24d electrical connectors, and of the HCFL T5, T8, T9 and T12 lamps with G5, G13 or R17d bi-pin electrical connectors, particularly in positions such as ceilings and lamp posts that are difficult to reach. The short life span of the HCFL is therefore causing significant difficulties owing to the frequent replacement needs, as well as the high positions that are difficult to reach. Moreover, these HCFL devices are not dimmable by ordinary wall dimmers. As such, it is highly desirable to have long-life and dimmable alternatives for them provided for by the CCFL type of T5, T8, T9 and T12 lamps and the CCFL type of plug-in lamps using G23 G24 or G24 electrical connectors, which can operate at high electricity power input.

### BRIEF SUMMARY OF THE INVENTION

In order to overcome the afore-described shortcomings and difficulties of the CCFL devices aiming for general lighting uses, an object of the present invention is to provide an improved CCFL gas discharge device with a compact form factor, that has a similar shape and dimension of a conventional incandescent light bulb, that can overcome the heat dissipation difficulties for both the CCFL filament and the electronic driver, so that it can generate high intensity illumination when operating at high electricity power input.

An improved CCFL gas discharge device comprising at least one cold cathode fluorescent lamp with at least one electrode is provided according to the present invention that is further comprising: an hermetically sealed light-transmitting container housing at least one CCFL filament inside; said container is filled with a high thermal conductivity gas such as the helium or the hydrogen gas that has better thermal conductivity than air; and an electronic driver providing high frequency of 10 k-150 k Hz and high voltage electricity of 500-2,500 volts is electrically connected to the electrodes of the CCFL.

One preferred embodiment of the present invention uses a hermetically sealed A-shaped glass bulb that is filled with the helium gas at a pressure of about 700 torr at room temperature. The luminous intensity of this embodiment, as shown in FIG.1, is about 30% higher than one with air filling inside the bulb.

In another preferred embodiment, the CCFL filament is coated with a gas diffusion barrier stopping the helium gas from diffusing into the inside space of the CCFL filament, the inner surface of the light-transmitting container is also coated with a gas diffusion barrier stopping the helium gas from leaking away from the container into the atmosphere, and soda lime glass is used to form the glass envelop for the CCFL filament and the light-transmitting container.

Another object of the present invention is to provide a novel method to fill a high thermal conductivity gas inside the light-transmitting container, and at the same time to affix the CCFL lamp filament within said container in a secured and anti-vibration manner. A preferred embodiment of the present invention accomplishes this object by connecting the CCFL filament to at least one lamp filament support member rigidly attaching to the stem head of a traditional lamp foot, which is bonded hermetically with the light-transmitting container.

The lamp foot has long been used for the incandescent light bulbs industry over a century, and owing to the massive demand, automated machines are available to make it in large volume and at low cost. Traditional machines for bonding lamp foot to the light-transmitting container are also abundant.

All commercially available lamp foots have three common features, i.e., (1) an inner exhaust tube along the center axis that has an opening just below the stem head, (2) a circular flange with an edge for sealing hermetically with the light-transmitting container, and (3) two metallic lamp filament support members attached rigidly to the stem head and connected electrically to the conducting wires extending to the bottom of the lamp foot.

The present invention has devised various methods of affixing the CCFL filament securely to the different filament support members that are rigidly attached to the lamp foot, so that it can withstand strong vibration impacts. After the CCFL filament is affixed to the lamp filament support members attached to the lamp foot and the metallic members of the lamp foot are connected to the electrodes of the CCFL filament, the flange at the bottom of the lamp foot is bonded to the bottom of the light-transmitting container, then air is evacuated from the container through the exhaust tube, a high thermal conductivity gas such as the helium gas is filled in, and the exhaust tube is sealed so that the light-transmitting container is hermetically sealed.

The present invention also provides other means to affix the CCFL filament within the light-transmitting container, which may or may not use the traditional lamp foot. One preferred embodiment is to attach the CCFL filament to a lamp filament support member of a predetermined shape, then attach said support member to the stem of a lamp foot, or onto the top of a base plate with an exhaust tube on its surface. Following that, either the edge of the lamp foot or the base plate is bonded with the bottom of the light-transmitting container forming a hermetical seal between them.

Another preferred embodiment is to attach the legs of the CCFL filament to in inner surface above the bottom of the light-transmitting container, then the bottom of said container is sealed hermetically with a base plate made of glass, ceramic or plastic and with an exhaust tube on its surface. Again, air is evacuated from the container through the exhaust tube of either the lamp foot or the base plate, a high thermal conductivity gas is filled inside, and the exhaust tube is then sealed.

Another object of the present invention is to provide an integral ballast assembly formed by a heat-conductive compound comprising a synthetic material that is embedding at least one portion of the electronic driver and filling the space between the electronic driver and the lamp base, so that heat generated by the electronic driver can be dissipated swiftly. A detachable and water-tight mold of a pre-determined shape is used for filling the heat-conductive compound. There is no casing or housing for the integral ballast assembly formed in this manner, as its surface is either the metallic surface of the lamp base at the bottom, or is the surface of the heat-conductive compound connecting immediately to the lamp base. The heat-conductive compound comprises a synthetic material such as an epoxy or a resin that also provides superior electrical insulation to the high-voltage transformer of the electronic driver, apart from serving as a thermal bridge between the components of the electronic driver and the lamp base.

Another embodiment of the invention provides a container connection member that is rigidly attached to the integral ballast assembly by the heat-conductive compound, and is at the same time insulated from the lamp base. As such, the container connection member can also be made of metallic material so that the heat generated by the electronic driver and by the CCFL electrodes can be swiftly dissipated into the atmosphere.

In another preferred embodiment, a two-parted mold is used to form the integral ballast assembly so it has a container connection opening on its top. It has the same shape and functionality as the one with a separately fabricated container connection member, but the manufacturing cost is lower, as the mold for forming such an integral ballast assembly can be used repeatedly, whilst the cost of the additional heat-conductive compound is cheaper than fabricating the container connection member separately.

There are many benefits of forming the integral ballast assembly using the above methods. For instance, the electronic driver is now placed at a further distance (than in the case of being placed inside a housing that is attached to the light-transmitting container) away from the CCFL electrodes, which is a main heat source that affects the electronic driver adversely. This enables the improved device to lower the operating temperature of its electronic driver, so it can have a longer operating life.

Moreover, it is no longer necessary to dispose the electronic driver in a separate housing that is attached to the light-transmitting container. Having such housing for a CCFL device is undesirable as its minimum wall thickness is about 1.5 mm on each opposite side, so that the inner space within the housing for the electronic driver is substantially reduced. Such housing must be attached directly to the lamp base, so it has to be made of plastic or ceramic materials that are poor heat conductors. Most importantly, with the housing for the driver, air is trapped inside, therefore causing the electronic driver to be overheated easily.

Another object is to improve the conventional CCFL devices so that these also benefit from the heat dissipation means provided by the present invention. Such conventional CCFL devices have housing for the electronic driver attached to the light-transmitting container. Though it is more difficult to assemble, filling a high thermal conductivity gas inside its light-transmitting container can still improve its light output by about 20%.

Another object of the present invention is to provide a long-life and dimmable CCFL alternatives to replace the ordinary HCFL plug-in lamps of 1U, 2U, 4U, 6U, and etc. shapes. Said CCFL alternatives use the same G23, G24 or G24d bi-pin or quad-pin electrical connectors as lamp bases or electrical connectors. Said alternatives have at least one CCFL coiled into spirals housing inside tubular light-transmitting, or is formed into 1U, 2U, 3U, or multi-U linear shaped lamps. These novel CCFL plug-in lamps with G23, G24 or G24d electrical connectors is for use with high electricity power input, so their containers are hermetically sealed with a high thermal conductivity gas inside.

Similarly, another object of the present invention is also to provide a long-life and dimmable CCFL alternatives for the HCFL fluorescent T5, T8, T9 and T12 lamps, which uses G5, G13 or R17d bi-pin lamp bases. Said alternatives contain at least one elongated CCFL filament that is linear shaped, or is in the form of a single spiral, a double spiral, a 2-Us, a 3Us or a multi-Us, housing inside the light-transmitting containers of T5, T8, T9 or T12 shape that is filled with a high thermal conductivity gas.

All the above and other objects, features, and advantages of the present invention will become apparent from the following detailed description of the different embodiments of the present invention, the accompanying drawings, and the enlisted claims. While not specifically described, it is understood that many of the features in the different embodiments may be used separately or in conjunction.

As such, the light-transmitting container of a small form factor may be A-shaped, pear-shaped, candelabra-shaped, globe-shaped, cylindrical-shaped, cone-shaped, MR16, MR103, and any other shapes commonly taken on by an ordinary incandescent light bulb. The material used to form the container can be glass, plastic, resin or metal coated with a reflective inner surface, or a combination of these different materials.

The CCFL filament can be bent into different shapes of U's, serpentine, cone, spiral, double-spiral and the like, so that the ultimate gas discharge fluorescent device has a small form factor of shape and size similar to an incandescent light bulb.

Additionally, each of the embodiments may employ more than one CCFL filament. In cases where two or more filaments are used, each may generate light of the same or different colors. The CCFL devices may be used for illumination, decoration, traffic lights or display devices. All such variations are within the scope of the present invention.

### BRIEF DESCRIPTION OF THE SEVERAL VIEWS OF THE DRAWINGS

The foregoing summary and the following detailed description of the invention will be better understood when read in conjunction with the accompanying drawings. For the purpose of illustrating the present invention, only the presently preferred embodiments are shown in the drawings, but it should be understood that the invention is by no means limited to the precise arrangements and instrumentalities shown in the drawings, which are briefly introduced below:

FIG. 1 is a graph showing the luminous output and lumen per watt of a 9 W CCFL device according to the present invention, comparing to those of a 9 W conventional CCFL device.

FIG. 2 is a cross-sectional view of a lamp body that is hermetically sealed with a CCFL filament and a high conductivity gas inside the light-transmitting container. The CCFL filament herein is supported by a glass lamp filament support member and by two metallic lamp support members connected to the electrodes of the CCFL filament.

FIG. 3 is a cross-sectional view of another lamp body that is hermetically sealed with a CCFL filament and a high conductivity gas inside the light-transmitting container. The CCFL herein has its arc-type legs rigidly affixed to the inner surface of the light-transmitting container by a bonding agent comprising a low-melting point solder glass or other silicone adhesives.

FIG. 4(a) is a cross-sectional view of a lamp foot with a lamp filament support member formed of a glass rod with a bead head; and FIG. 4(b) is a cross-sectional view of a CCFL lamp body with its CCFL filament affixed to the lamp filament support members and lamp foot of FIG. 4(a).

FIG. 5(a) is a cross-sectional view of a lamp foot with a lamp filament support member formed of a glass rod with two hooks attached to a bead head; and FIG. 5(b) is a cross-sectional view of a CCFL lamp body with its CCFL filament affixed to the lamp filament support members and lamp foot of FIG. 5(a).

FIG. 6(a) is the cross-sectional view of a prong-type lamp filament support member for affixing a CCFL filament with prong-type legs, and a lamp foot without lamp filament support members; and FIG. 6(b) is the cross-sectional view of a lamp body comprising the lamp filament support member and lamp foot of FIG. 6(a), a CCFL filament with prong-type legs, and with a high thermal conductivity gas filled inside its light transmitting container.

FIG. 7(a) is the cross-sectional view of an arc-type lamp filament support member for affixing a CCFL filament with arc-type legs, and a lamp foot without a lamp filament support member; and FIG. 7(b) is the cross-sectional view of a lamp body comprising the lamp filament support member and lamp foot of FIG. 7(a), a CCFL filament with arc-type legs, and with a high thermal conductivity gas filled inside its light transmitting container.

FIG. 8(a) is the cross-sectional view of a prong-type lamp filament support member attached to a base plate with an exhaust hole on its surface; and FIG. 8(b) is the cross-sectional view of a lamp body comprising the prong-type lamp filament support member and the base plate of FIG. 8(a), a CCFL filament with arc-type legs, and a high thermal conductivity gas filled inside its light transmitting container.

FIG. 9(a) is the cross-sectional view of an arc-type lamp filament support member attached to a base plate with an exhaust tube on its surface; and FIG. 9(b) is the cross-sectional view of a lamp body comprising the arc-type lamp filament support member and the base plate of FIG. 9(a), a CCFL filament with arc-type legs, and a high thermal conductivity gas filled inside its light transmitting container.

FIG. 10(a) is the cross-sectional view of a lamp body comprising a prong-type CCFL filament affixed to the inner surface at the bottom of a light-transmitting container which is hermetically sealed with a base plate at the bottom.

FIG. 10(b) is the cross-sectional view of a lamp body comprising an arc-type CCFL filament affixed to the inner surface at the bottom of a light-transmitting container which is hermetically sealed with a base plate at the bottom.

FIG. 11(a) is the cross-sectional view of a mold for forming an integral ballast assembly, together with the components of said assembly before a heat-conductive compound is filled inside; and FIG. 11(b) is the cross-sectional view of an integral ballast assembly formed with the mold of FIG. 11(a).

FIG. 12(a) is the cross-sectional view of a lamp body, a container connection member and an integral ballast assembly; and FIG. 12(b) is the cross-sectional view of a fully assembly CCFL device with a container connection member connecting both its lamp body and its integral ballast assembly.

FIG. 13(a) is the cross-sectional view of a container connection member with a container support member that tilts upward; and FIG. 13(b) is the cross-sectional views of an integral ballast assembly integrally formed with the container connection member of FIG. 13(a).

FIG. 14 is the cross-sectional view of a fully assembly CCFL device using the integral ballast assembly of FIG. 13(b) to connect to a lamp body of FIG. 3.

FIG. 15 is the cross-sectional view of a fully assembly CCFL device using the integral ballast assembly of FIG. 13(b) to connect to a lamp body of FIG. 4(b).

FIG. 16 is the cross-sectional view of a fully assembly CCFL device using the integral ballast assembly of FIG. 13(b) to connect to a lamp body of FIG. 5(b).

FIG. 17 is the cross-sectional view of a fully assembly CCFL device using the integral ballast assembly of FIG. 13(b) to connect to a lamp body of FIG. 6(b).

FIG. 18 is the cross-sectional view of a fully assembly CCFL device using the integral ballast assembly of FIG. 13(b) to connect to a lamp body of FIG. 7(b).

FIG. 19(a) is the cross-sectional view of a container connection members with a container support member that is flat and points horizontally; and FIG. 19(b) is the cross-sectional view of an integral ballast assembly integrally formed with the container connection member of FIG. 19(a).

FIG. 20 is the cross-sectional view of a fully assembly CCFL device using the integral ballast assembly of FIG. 19(b) to connect to a lamp body of FIG. 8(b).

FIG. 21 is the cross-sectional view of a fully assembly CCFL device using the integral ballast assembly of FIG. 19(b) to connect to a lamp body of FIG. 9(b).

FIG. 22 is the cross-sectional view of a fully assembly CCFL device using the integral ballast assembly of FIG. 19(b) to connect to a lamp body of FIG. 10(a).

FIG. 23 is the cross-sectional view of a fully assembly CCFL device using the integral ballast assembly of FIG. 19(b) to connect to a lamp body of FIG. 10(b).

FIG. 24(a) is the cross-sectional view of another container connection member that is smaller than both the ones of FIG. 13(a) and FIG. 19(a); and FIG. 24(b) is the cross sectional view of another integral ballast assembly integrally formed with the container connection member of FIG. 24(a); and FIG. 24(c) is the cross-sectional view of a fully assembly CCFL device using the integral ballast assembly of FIG. 24(b) to connect to a lamp body with the normal A19 shaped glass container of an ordinary incandescent light bulb.

FIG. 25 is the cross-sectional view of a mold used to form an integral ballast assembly that has its own container connection opening formed by the same heat-conductive compound embedding the electronic driver, together with the various modules of the electronic driver and the lamp base that are disposed inside the mold.

FIG. 26(a) is the cross sectional view of an integral ballast assembly formed form the mold of FIG. 25, that has its own container connection opening that tilts upward; and FIG. 26(b) is the cross-sectional view of a CCFL device using the integral ballast assembly of FIG. 26(a) attaching to a smaller lamp body similar to that of FIG. 2.

FIG. 27(a) is the cross sectional view of another integral ballast assembly formed form a mold similar to that of FIG. 25, that has its own container connection opening which is flat and pointing horizontally; and FIG. 27(b) is the cross-sectional view of a CCFL device using the integral ballast assembly of FIG. 27(a) attaching to a smaller lamp body similar to that of FIG. 10(a).

FIG. 28(a) is the cross sectional view of another integral ballast assembly formed by a smaller mold, that has its own container connection opening which also pointing upward; and FIG. 28(b) is the cross-sectional view of a CCFL device using the integral ballast assembly of FIG. 28(a) attaching to a smaller lamp body similar to that of FIG. 24(c).

FIG. 29 is the cross-sectional view of a CCFL device that places its electronic driver in a housing attached to the light-transmitting container, and the lamp body is similar to that of FIG. 2.

FIG. 30 is the cross-sectional view of a CCFL device that places its electronic driver in a housing attached to the light-transmitting container, and attach its CCFL filament to a lamp filament support member that is connected to the light transmitting container and is also attached to the housing for the electronic driver. Its light transmitting container is hermetically sealed with a high thermal conductivity gas inside.

FIG. 31 is the cross-sectional view of a CCFL device that has two tubular light-transmitting containers. A high thermal conductivity gas is filled inside said containers that are attached to a 4-pin G23 electrical connector. The device does not have an electronic driver of its own, and its two tubular light-transmitting containers are hermetically sealed, and each is housing a 3-U linear CCFL filament inside.

FIG. 32 is the perspective view of a CCFL T8 tubular device with a 3-U linear CCFL filament housing inside its light-transmitting container, which is hermetically sealed with a high thermal conductivity gas inside, and has a bi-pin G13 electrical connector on both ends.

FIG. 33 is the cross-sectional view of a CCFL T12 tubular device with two 3-U linear filaments housing inside its light-transmitting container, which is hermetically sealed with a high thermal conductivity gas inside.

FIG. 34 is the cross-sectional views of a similar device of FIG. 33 except that each has six linear CCFL filaments housing inside the light-transmitting containers, and the electrodes of the CCFL filaments are arranged in such a manner that only each bi-pin connector on both sides of the light transmitting container are electrically coupled to the electrodes on each of their same sides.

FIG. 35 is the cross-sectional views of a similar device of FIG. 34 except that the electrodes of the CCFL filaments are arranged in such a manner that only one bi-pin connector on one side of the light transmitting container is electrically coupled to the electrodes on both ends of the light transmitting container.

FIG. 36 is the same CCFL device of FIG. 35, except that there is no high thermal conductivity gas filled inside the light-transmitting container.

### DETAILED DESCRIPTION OF THE INVENTION

Hereinafter, the details of the present invention and its preferred embodiments are described with reference to the accompanying drawings. In the accompanying drawings, for simplicity in description, identical components are labeled by the same numerals.

### EMBODIMENT 1

The first embodiment of the present invention provides a novel heat dissipation means for an CCFL device that is comprising: an hermetically sealed light-transmitting container housing at least one CCFL filament inside; an electronic driver providing high-frequency and high-voltage electricity is electrically connected to the electrodes of the CCFL filament, and is also connected to a lamp base that receives external electricity from a electrical socket, and said container is filled with a high thermal conductivity gas that has better thermal conductivity than air, so that the heat generated from the CCFL filament can be dissipated swiftly into the atmosphere through the surface of the light-transmitting container.

In the embodiment immediately above, and in other embodiments described below, there are many obvious variations for forming said CCFL device. For instance, the electronic driver can be a DA/AC or AC/AC converter, i.e., the input electricity current can be either AC or DC, and the output electricity for the CCFL is high-voltage and high-frequency electricity, with voltage of at least 80 volts and frequency of 10 k-150 kHz. The lamp base (also known as the electrical connector) can be one of the many conventional lamp bases, which are for mechanical and electrical connection to conventional power outlets, thereby supplying either AC or DC power to said electronic driver. Last but not the least, the light-transmitting container may be any shapes of the conventional incandescent light bulbs, and it can be made of glass or plastic, transparent or translucent (i.e. transmits diffuse light), or may transmit light of only certain color or colors, and it may also comprise in part an inner reflective surface. All these variations are with the scope of the present invention through the various embodiments described herein.

In a preferred embodiment, a high thermal conductivity gas with thermal conductivity better than air is filled inside the light-transmitting container. There are three light molecular weight gaseous elements having thermal conductivity better than air, namely, hydrogen, helium and neon. Each of them can be used solely or as a mixture with each other, not withstanding the sole or mixture gas may have impurities or a small portion of other heavier molecular weight gases inside, so long as its resultant thermal conductivity is better than that of air. Hereafter in the specification of the present invention, such a gas or a gas mixture that has thermal conductivity better than air is referred to as a high thermal conductivity gas.

The hydrogen gas is the lightest molecular weight gas on earth and its thermal conductivity of 180.5 mW/m-K (at 300. deg.K) is about 6.8 times of air's thermal conductivity of 26.4 mW/m-K. The helium gas is the second lightest molecular weight gas after hydrogen, and its thermal conductivity is 151.3 mW/m-K, being 5.7 times of air. The neon gas is the third lightest molecular weight gas after helium, with thermal conductivity of 49.1 mW/m-K, 1.9 times of air. The first two, i.e. hydrogen and helium, are the preferred heat-conductive media according to the present invention. However, given hydrogen is flammable when mixed with air, helium is more preferred despite the lower thermal conductivity. Still, a combination of helium and hydrogen is also preferred, particularly when the composition of hydrogen is about 8.5% with the rest being helium. Such a composition, commonly known as an “electron capture gas”, is not flammable and is easily available from the industrial gas suppliers.

An embodiment of the present invention provides an A-shaped glass bulb with similar size to an ordinary incandescent light bulb, which is hermetically sealed and filled with helium gas at a pressure of about 700 torr at room temperature.

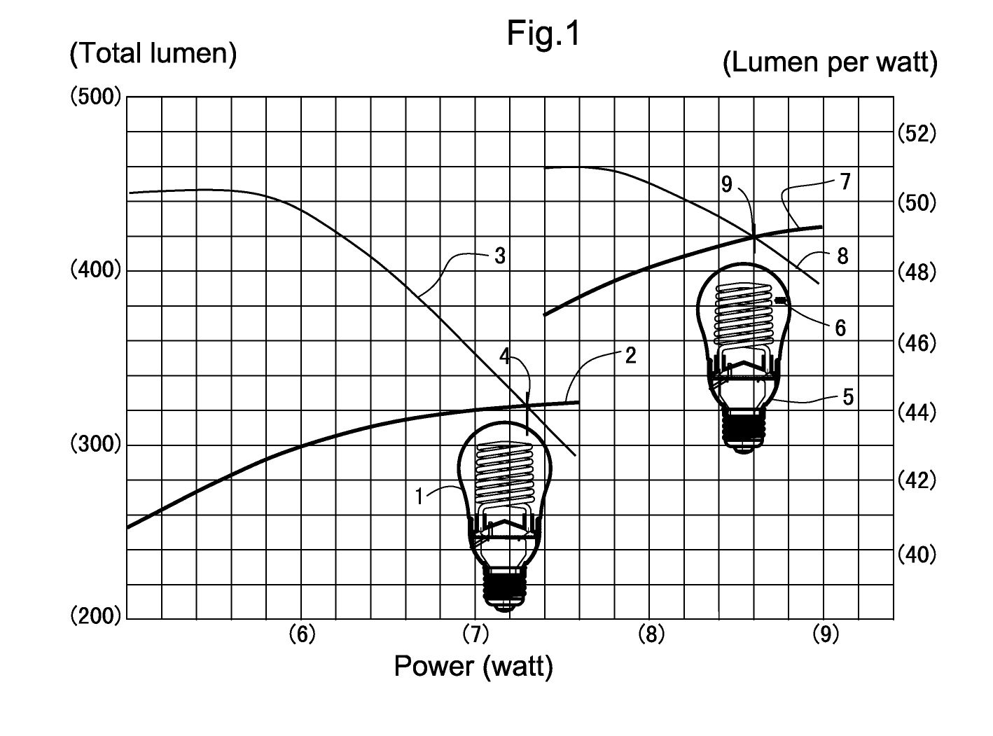

Referring to FIG. 1, five random samples of an existing 9 W model of a conventional A-shaped CCFL lamp 1, which are filled with air inside their light-transmitting containers, are powered on at different voltages. Their luminous intensities are recorded 30 minutes after lamp start when the light output stabilized at various stabilized power consumptions between 6 and 8 watt. The average stabilized wattages of them are about 2 watts lower than the initial operating wattages for each lamp, which is typical of a conventional CCFL device that is somewhat overheated but is not yet excessively overheated. If it is excessively overheated, its luminous output drops unintentionally despite the input power being stable or increasing.

The average lumen per lamp, as well as the average lumen per watt of the five samples of lamp 1 are depicted as curve 2 and curve 3 in FIG. 1, respectively. The meeting point 4 of said curves shows lamp 1 has a more efficient output at about 7.4 watt, when the average light output per lamp is about 323 lumens, and the average efficiency is about 44.2 lumens per watt. The efficiency falls rapidly with further increases in the power input, as light output per lamp no longer increases.

Also referring to FIG. 1, the same five samples of lamp 1 is converted to lamp 5 after air is evacuated from their light-transmitting containers, and the helium gas 6 is filled inside at about 700 torr of pressure at room temperature. After powered on, their luminous intensities are recorded at different stabilized electricity consumption of between 7 and 9 watts, 30 minutes after lamp start when the light output is also stabilized. Different from lamp 1, the average stabilized wattage of lamp 5 is about 0.7 watt below its average initial operating wattage, indicating that there is no overheating.

Again referring to FIG.1, the average lumen per lamp of lamp 5, as well as the average lumen per watt of lamp 5 are computed and depicted as curve 7 and curve 8, respectively. The meeting point 9 of said curves shows the efficient output of lamp 5 is achieved at about 8.6 watt, when the average light output per lamp is about 420 lumens, and the average efficiency is about 48.8 lumens per watt. As the stabilized power consumption drops about 0.7 watt only when the helium gas is filled inside the light-transmitting container, instead of falling by 2.0 watt when filled with air, there is an 18% increase in the utilized power. On the other hand, there is 10% gain in the light output efficiency after the helium gas is filled. As such, the total luminous intensity per lamp improves by 30% after the helium gas replaces the air within the light-transmitting container. It means the overheating problem of the CCFL device is successfully overcome.

When a HCFL operates at about 9 watt without being enclosed in a light-transmitting shell, i.e., in the bare lamp mode, the surface of its lamp body is about 50-60. degree.C. at a position about 1.0 cm away from the hot cathode, and the temperature of the lamp body surface near the hot cathodes is double at 100-120. degree.C., due mainly to the fact that the tungsten wire inside the hot-cathode operates at about 800-1,000. degree.C.

For the CCFL operates at the same power range of about 9 watt and in a bare lamp mode without being enclosed in light-transmitting shell, the surface of its lamp body 1.0 cm away from the cold electrode is about 35-40. degree.C., whereas the temperature of the lamp body surface near the cold cathodes is about 60-70. degree.C., as the cold cathode inside the lamp filament has an operating temperature of 90-110. degree.C.

Due mainly to the lower overall body temperature of the CCFL compared with the HCFL, the present invention featuring the use of a high thermal conductivity gas inside the container solves the heat-dissipation difficulty of the CCFL device entirely satisfactorily when it operates at power range of 9 watt or more. In contrast, however, using the same feature for the HCFL, the effect is not entirely satisfactory, as it only produces about 15% better light output.

### EMBODIMENT 2

Another embodiment of the present invention provides a novel method stopping the helium or hydrogen gases leaking away from the light-transmitting container, and also stopping them from diffusing into the inside of the CCFL lamp filament which is of lower partial helium or hydrogen pressure than the inside of the light-transmitting container. Helium and hydrogen can normally diffuse through the glass container and the hermetical seals between the glass container and other lamp body surfaces. According to the present invention, soda lime glasses is used for the light-transmitting container and for the glass envelope of the CCFL filament, as the helium and hydrogen permeation rates through soda lime glass are several thousand times less than those through quartz, borosilicate and Pyrex glass under room temperature. Moreover, for the other parts of the lamp body, such as the container connection member, metal such as aluminum or copper is preferred, as the helium and hydrogen gases do not normally diffuse through metals.

Furthermore, in order to block helium and hydrogen diffusing into the interior space of the CCFL filament, a gas diffusion barrier is coated on the outside surface of the CCFL filament. Such a gas diffusion barrier is also applied to the inside surface of the light-transmitting container to stop helium or hydrogen inside from leaking out to the atmosphere.

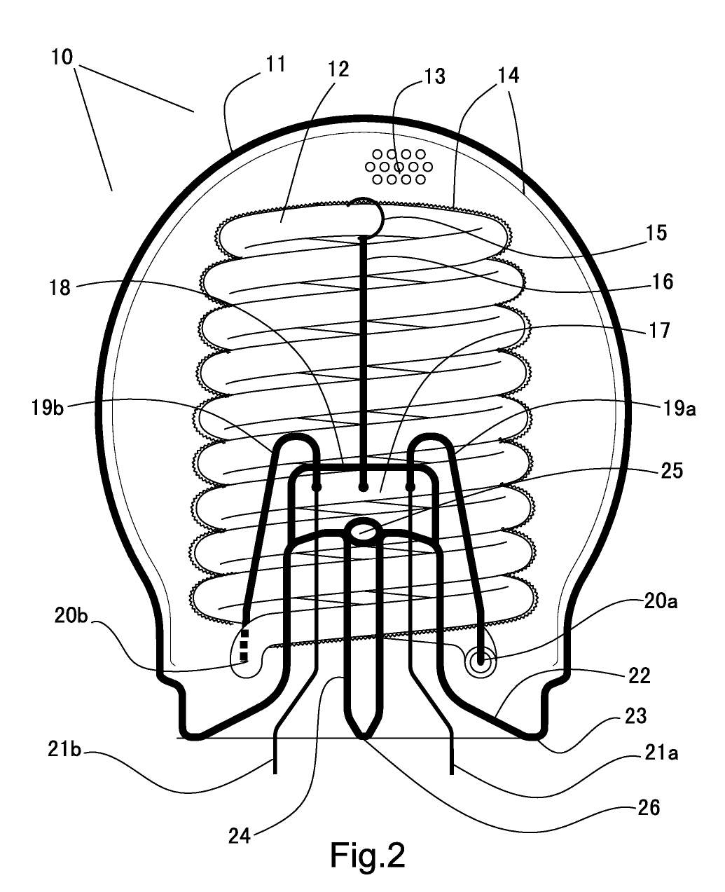

Referring to FIG. 2 and according to the present invention, lamp body 10 comprises a light-transmitting container 11, which houses CCFL filament 12 inside. The light-transmitting container 11 is hermetically sealed and is filled with a high thermal conductivity gas 13 which is the helium gas in this case. The gas diffusion barrier 14 is coated both on the outer surface of the CCFL filament 12 and on the inside surface of the light-transmitting container 11.

According to the Patent Publication No. SHO 42-16002 (Shimizu Patent Office, Fukiai-Ku, Kobe, Japan) granted to Yasunori Nikaido, et al., helium penetration through a glass surface can be blocked by a thin layer of an epoxy-Epon 828 resin (registered trademark of Shell Chemical Company) and Belsamid 125 hardening agent (registered trademark of General Mills Incorporated). According to the present invention, such an epoxy and hardening agent combined, and the likes, are preferred materials for forming the gas diffusion barrier. Also according to the present invention, a effective gas diffusion barrier can be formed by coating a transparent layer formed of a mixture of aluminum oxide (Al.sub.2.O sub.3) and silicon oxide (Si.sub.×.O.sub.y,x=1 to 4, y=1 to 5) at ratio of about 3:2 to 5:1 on the outside surface of the lamp filament, as well as on the inside surface of the light-transmitting container.

### EMBODIMENT 3

Another embodiment of the present invention provides a novel means to affix the CCFL lamp filament within the light-transmitting container in a secured and vibration-proof manner, and at the same time, to allow air be evacuated from, and a high thermal conductivity gas be filled inside said container. This is accomplished by affixing the CCFL lamp filament to a traditional lamp foot that has been used for the incandescent light bulbs for over a century. A lamp foot is formed from a short and hollow glass tube of outer diameter 5-10 mm and inner diameter 3-7 mm so that the tube body is about 1 mm thick. Owing to the massive demand, automated machines are available to make lamp foots in large volumes and at low cost, and existing automated machines for bonding lamp foots to the light-transmitting containers are abundant.

Commercially available lamp foots have many different formats, but all have three common features, i.e., (1) an inner glass exhaust tube along its axis, with an opening at the point where the exhaust tube meets the stem head, (2) a circular flange base for sealing hermetically with the bottom of the light-transmitting container, and (3) two metal-wire lamp filament support members rigidly attached to the stem head and connected electrically to the conducting wires extending from the stem head to the bottom and outside of the lamp foot. Depending on the different need, a lamp foot may have one or more additional filament support members attached to the stem head and are not connected to the electricity conducting wires.

Also referring to FIG.2 and according to the present invention, the top of CCFL filament 12 is securely affixed to the hook 15 of the filament support member 16 that is rigidly attached to the stem head 17 of the lamp foot 18. At the same time, each of the electrical conductors (not shown) connecting to the CCFL electrodes (not shown) is welded to the first ends of the two other filament support members 19a and 19b at to the positions 20a and 20b, respectively, near to the end of the legs of the CCFL filament 12. The second ends of the filament support members 19a and 19b are rigidly attached to the stem head 17 of lamp foot 18, and are also electrically connected to the conducting wires 21a and 21b, respectively, leading to the outside of lamp body 10 from the bottom of the lamp foot 18. With the three point connections at positions 15, 20a and 20b of the lamp filament support members 16, 19a and 19b, respectively, the CCFL filament 12 is securely affixed inside the lamp body 10, and it can withstand strong vibrations as the filament support members 16, 19a and 19b are formed of thick metallic wires, which are mechanically strong, but can flexibly be bent and restore their original positions afterward.

Again referring to FIG. 2, after the CCFL filament 12 is affixed to lamp support members that are attached to the lamp foot 18, the circular flange 22 of lamp foot 18 is bonded to the bottom of the light-transmitting container at position 23, forming into a hermetical seal using the traditional lamp foot bonding machines. Following that, air is evacuated from the light-transmitting container through the exhaust tube 24 that has an inner opening 25 below the stem head 17, and has another opening 26 at the bottom that is sealed after the high thermal conductivity gas 13 is filled inside.

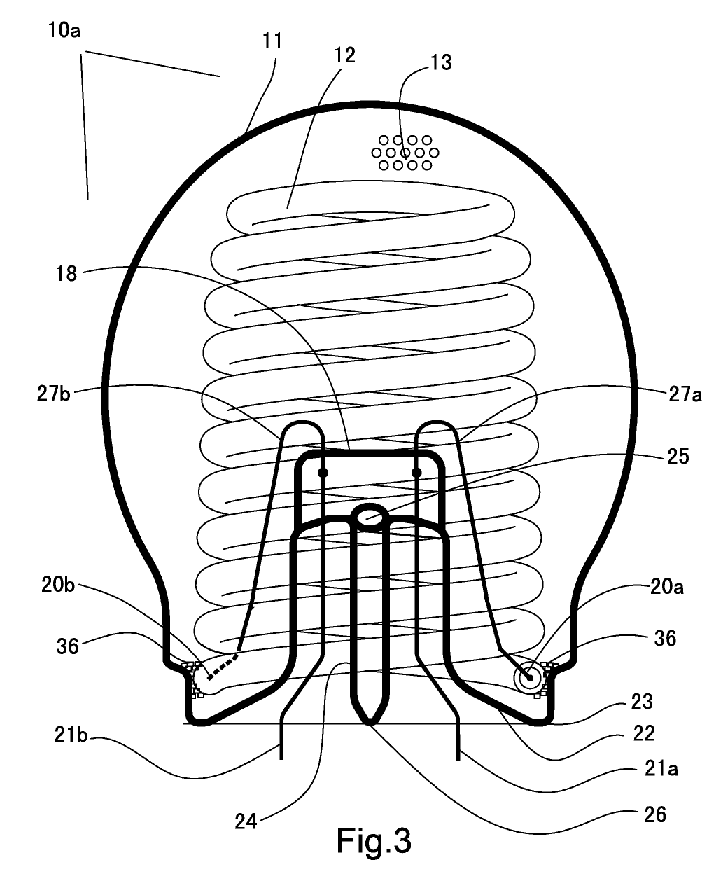

Referring to FIG. 3, the lamp foot 18 is attached with only two metallic lamp filament connectors 27a and 27b. The CCFL filament 12 having two arc-type legs securely affixed to the inner surface at the lower portion of the light-transmitting container 11 by a bonding agent 36 comprising a silicone gel such as RTV, a low melting point solder glass or other heat-enduring adhesives. The two lead wires (not shown) connecting the electrodes (not shown) of the CCFL filament 12 are soldered to the first ends of the two metallic lamp filament connectors 27a and 27b at the positions 20a and 20b, respectively. The second ends of the two metallic lamp filament members 27a and 27b are rigidly attached to the stem head 17 of lamp foot 18, and are also electrically connected to the conducting wires 21a and 21b, respectively, leading to the outside of lamp body 10 from the bottom of the lamp foot 18. With its arc-type legs bonded to the inner surface of the light-transmitting container 11, the CCFL filament 12 is securely affixed inside the lamp body 10, and it can withstand strong vibrations. The heat generated by its electrodes can also be swiftly conducted to the surface of the light-transmitting container 11 through the bonding agent 36.

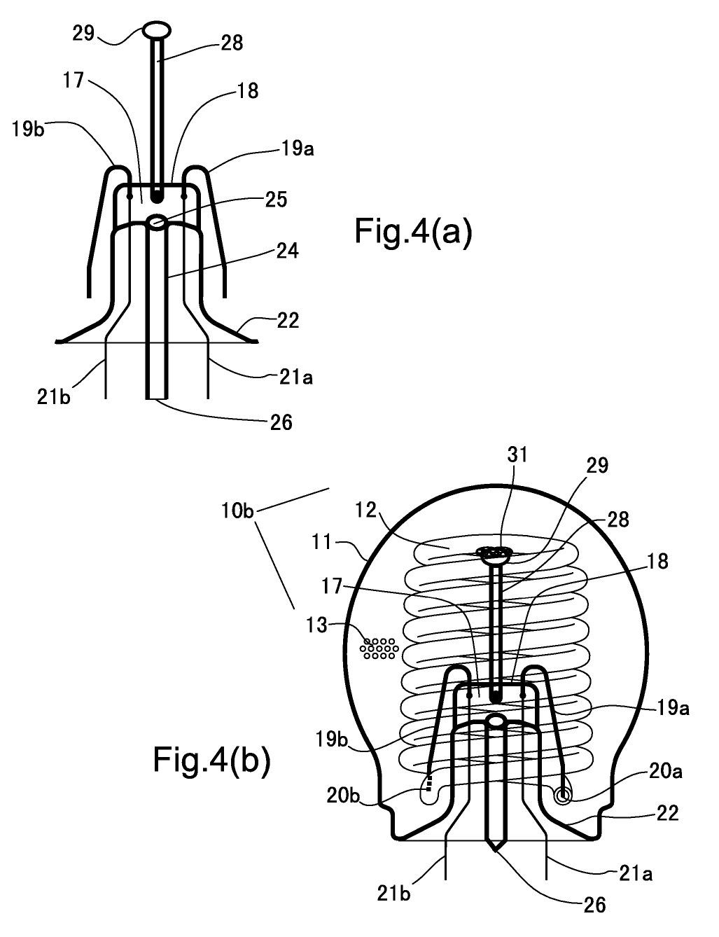

Referring to FIG. 4(a), the middle lamp filament support member of the lamp foot 18 is the glass rod 28, which has a slightly bigger bead head 29 providing a large surface area for gluing itself to the top of the CCFL filament by a silicone or other heat enduring adhesives. Referring to FIG. 4(b), lamp body 10b comprises the lamp foot of FIG. 4(a), the top of its CCFL filament 12 is attached to the bead head 29 by RTV or other adhesives 31, and its other two connections with the remaining lamp filament support members 19a and 19b are same as those of FIG. 2.

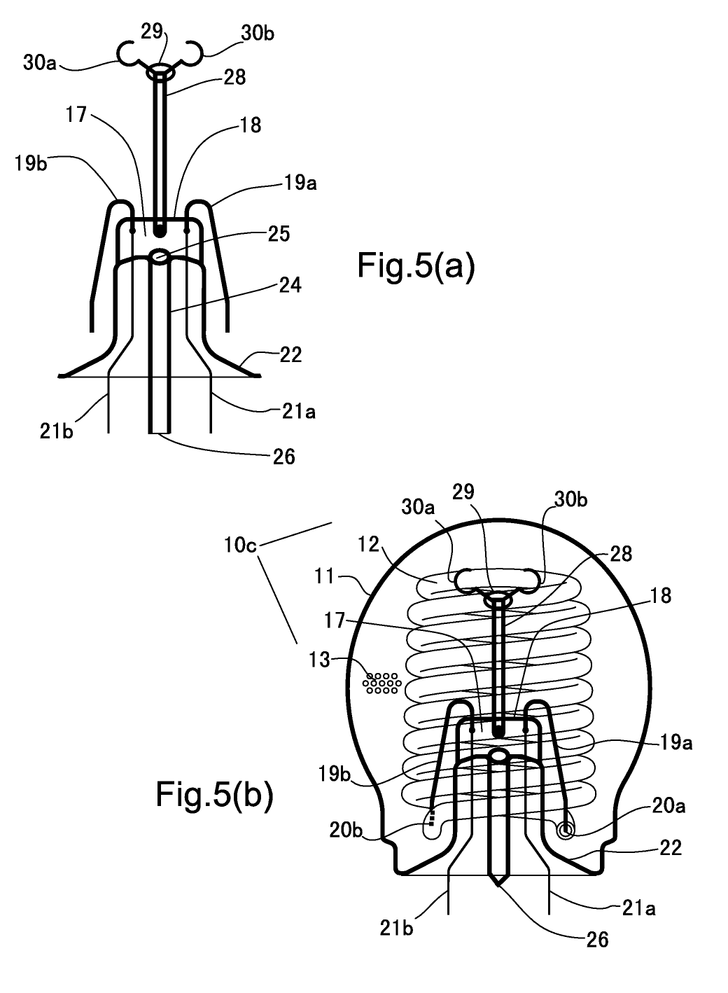

Referring to FIG. 5(a), the lamp foot 18 is similar to that of FIG. 4(a), but the bead head 29 has two metallic hooks 30a and 30b for attaching to the top of the CCFL filament 12. Referring to FIG. 5(b), for lamp body 10c, CCFL filament 12 has its top portion securely attached to two metallic hooks 30a and 30b of lamp filament support member 28 that has the bead head 29, and its other two connections for the remaining lamp filament support members 19a and 19b are same as that of FIG. 4(b).

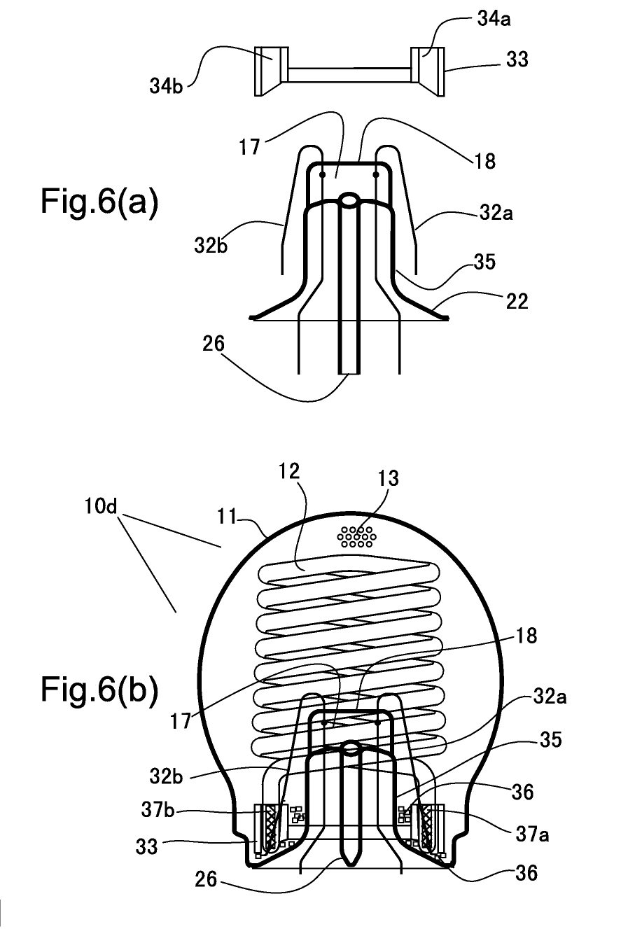

In another preferred embodiment, the CCFL filament 12 is affixed to a lamp foot by using a different lamp filament support member. Referring to FIG. 6(a), the previously thick metal-wire filament support members 19a and 19b of lamp foot 18 become a pair of thin conducting wires 32a and 32b that do not have mechanical strength to support the CCFL filament 12, and there is no other lamp support member attached to the stem head 17 of the lamp foot 18. Instead, a lamp filament support member 33 with two prong type cavities 34a and 34b is used, and this can be made of glass, metal, ceramic or plastic materials.

Referring to FIG. 6(b), the legs of CCFL filament 12 is inserted and glued to the prong-type cavities of lamp filament support member 33, which is then affixed to the circular stem 35 of lamp foot 18, using bonding agent 36 which comprises silicone gel such as RTV, or low melting point solder glass. The conducting wires 32a and 32b are then connected to the electrodes 37a and 37b, respectively, of the CCFL filament 12. The remaining processes of forming the lamp body 10d with a high thermal conductivity gas hermetically sealed inside are same as forming lamp body 10 of the previous embodiment referring to FIG. 2.

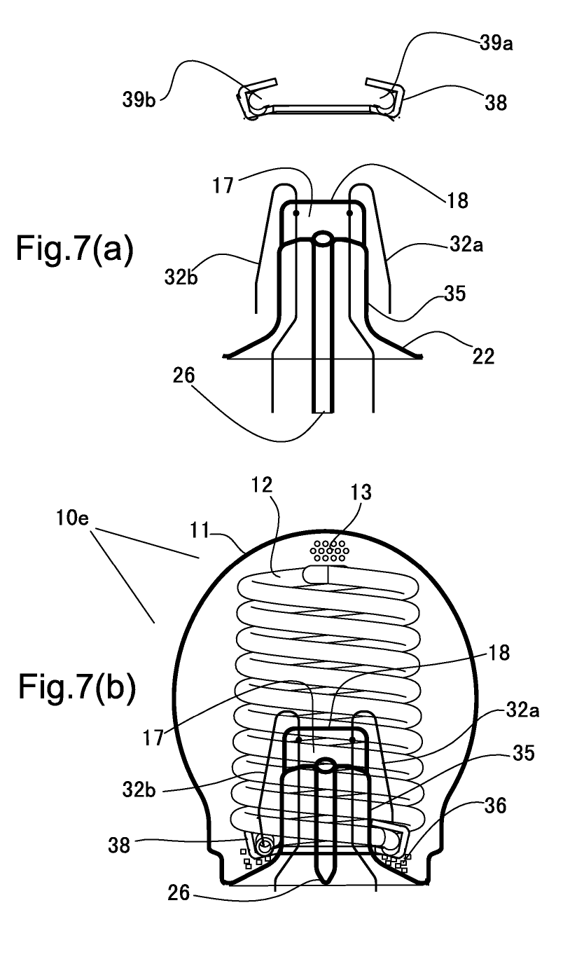

Referring to FIG. 7(a) and FIG.7 (b ), the CCFL filament 12 is having two arc-type legs instead of the one of FIG. 6(b) that has prong-typed legs. As such, another type of lamp filament support member 38 is used, which has two arc-type cavities 39a and 39b for adopting the arc-type legs of CCFL filament 12. Lamp filament support member 38 is affixed to the circular stem 35 of lamp foot 18, using bonding agent 36 which comprises silicone gel such as RTV, low melting point solder glass or other heat-enduring adhesives. The conducting wires 32a and 32b are connected to the electrodes (not shown) of the CCFL filament 12. The remaining processes of forming the lamp body 10e with a high thermal conductivity gas hermetically sealed inside are same as forming lamp body 10 of the previous embodiment referring to FIG. 2.

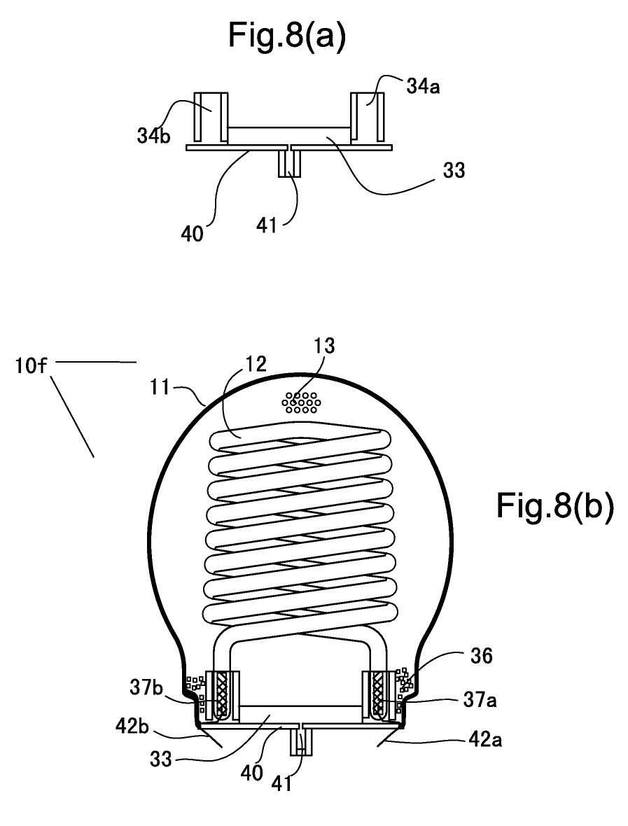

In another preferred embodiment, referring to FIG. 8(a) the filament support member 33 is attached to a base plate 40 by bonding agent (not shown) which comprises silicone gel such as RTV, low melting point solder glass or other heat-enduring adhesives. The base plate 40 is of size similar to the area of the bottom of the light-transmitting container, and it has an exhaust tube 41 through its surface.

Referring to FIG. 8(b), the prong-type legs of CCFL filament 12 of lamp body 10f is inserted and bonded securely by RTV or other adhesives to the prong-type cavities 34a and 34b of lamp filament support member 33 attached to base plate 40. Following that, the outer circumference of the base plate 40 is bonded hermetically to the bottom of the light-transmitting container 11, using bonding agent 36 which comprises silicone gel such as RTV, or a low melting point solder glass. During the bonding process, conducting wires 42a and 42b leading from the CCFL electrodes 37a and 37b penetrate though the hermetic seals to the outside of the lamp body 10f at its bottom. These conducting wires have similar thermal expansion coefficient as the bonding agent 36, so the hermetical seal between the base plate 40 and the container 11 is preserved. Finally, air is evacuated through the exhaust tube 41, and a high thermal conductivity gas is filled inside the light-transmitting container, and the exhaust tube 41 is sealed off.

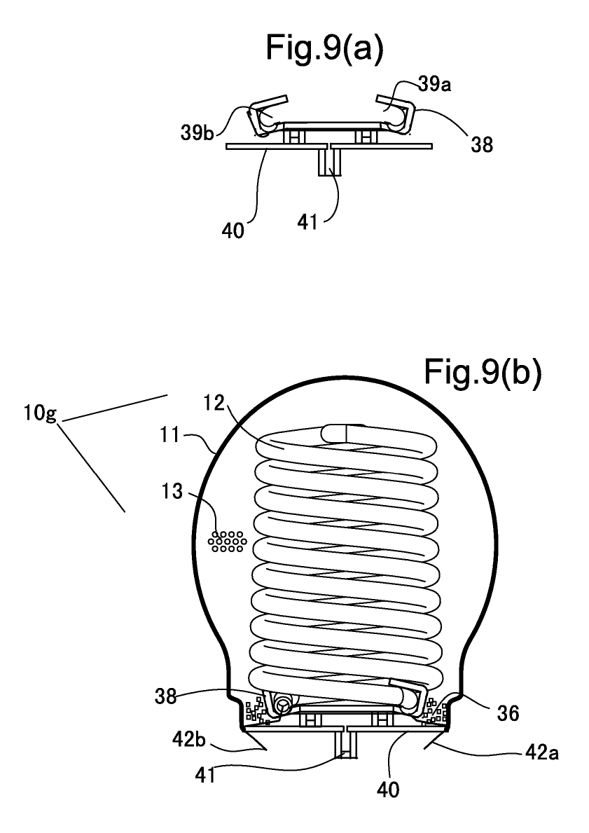

Referring to FIG. 9(a), another type of filament support member 38 with arc-type cavities 39a and 39b is attached to a base plate 40 by bonding agent (not shown) which comprises silicone gel such as RTV, low melting point solder glass or other heat-enduring adhesives. The base plate 40 is of size similar to the area of the bottom of the light-transmitting container, and it has an exhaust tube 41 through its surface.

Referring to FIG. 9(b), the lamp body 10g has the same feature as the lamp body 10f of FIG. 8(b), except that is CCFL filament 12 has a pair of arc-type instead of prong-type legs, therefore, the arc-type lamp filament support member 38 is used.

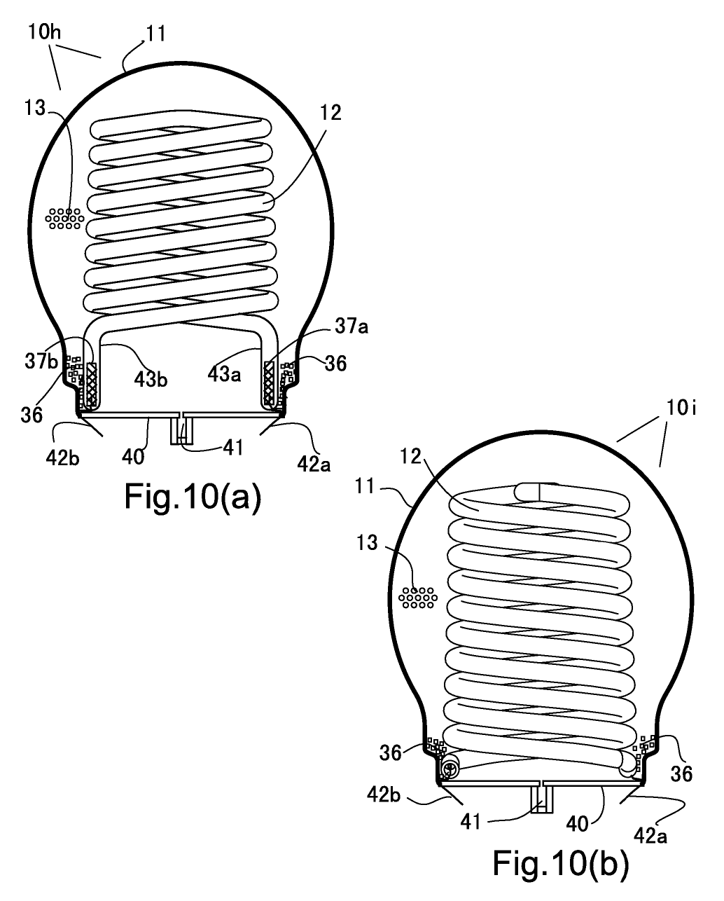

In another preferred embodiment, the CCFL filament 12 is affixed directly to the inner surface at the bottom of the light-transmitting container, so that a lamp filament support member is no longer required. Referring to FIG. 10(a), the two prong-type legs 43a and 43b of CCFL filament 12 of lamp body 10h is attached to the bottom inner surface of light-transmitting container 11 by bonding agent 36 that comprises a low melting point solder glass, epoxy, RTV silicone or other adhesives. The outer circumference of the base plate 40 is then bonded hermetically to the bottom of the light-transmitting container 11, using the same bonding agent 36. Conducting wires 42a and 42b leading from the CCFL electrodes 37a and 37b, respectively, penetrate though the hermetic seals to the outside of the lamp body 11 at its bottom. The conducting wires 42a and 42b have similar thermal expansion coefficient as the bonding agent 36, so the hermetical seal between the base plate 40 and the container 11 is preserved. Finally, air is evacuated through the exhaust tube 41, and a high thermal conductivity gas is filled inside the light-transmitting container, and the exhaust tube 41 is sealed off.

Referring to FIG. 10(b), the lamp body 10i has the same feature as the lamp body 10h of FIG. 10(a), except that its CCFL filament 12 has a pair of arc-type legs, which are also bonded securely to the inner surface light transmitting container 11 at its bottom, by using bonding agent 36.

In the foregoing descriptions for the various embodiments of forming the hermetically sealed lamp bodies of the present invention, the light-transmitting container may has an A shape, a pear shape, a candelabra shape, a globe shape, a cylindrical shape, a cone shape, a MR16 shape, a MR103 shape, or any other shapes commonly taken on by an ordinary incandescent light bulb. The material used to form the container can be glass, plastic, resin or metal coated with a reflective inner surface, or a combination of these different materials. Additionally, each of the embodiments may employ more than one CCFL filament. In cases where two or more filaments are used, each may generate light of the same or different colors.

### EMBODIMENT 4

Another embodiment of the present invention provides an integral ballast assembly formed by a heat-conductive compound comprising a synthetic material filling the entire space between the electronic driver and the lamp base air-tightly, so that heat generated by the electronic driver is dissipated swiftly through the surface of the integral ballast assembly. The synthetic material comprises an epoxy, silicone, or synthetic resin that is heat-conductive and provides electrical insulation to the high-voltage transformer of the electronic driver. It also serves as a thermal bridge between the components of the electronic driver and the lamp base.

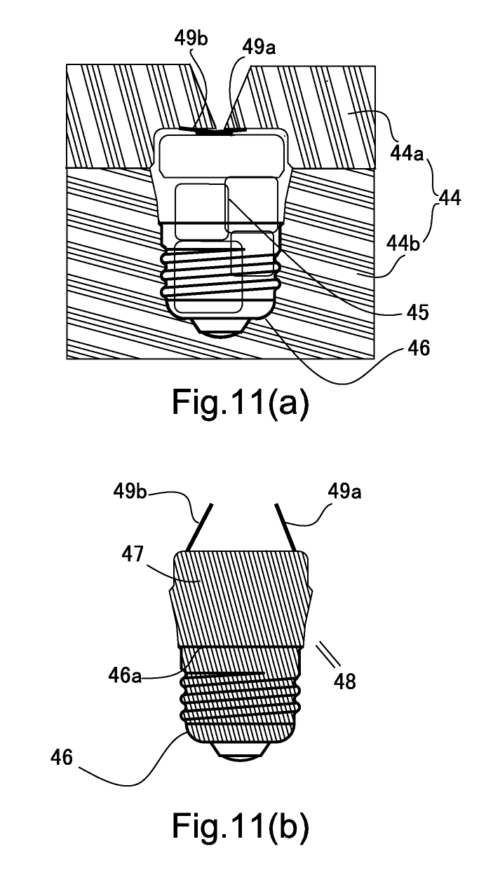

Referring to FIG. 11(a), a two-part detachable and water-tight mold 44, with upper-part mold 44a and lower-part mold 44b is used for filling the heat-conductive compound (not shown) by hand or by using a vertical type plastic/resin injection machine. Before filling in the heat-conductive compound, the different modules of the electronic driver 45 and the lamp base 46 is properly connected and securely disposed inside a two-part mold 44.

Referring to FIG. 11(b), after the heat-conductive compound 47 comprising a synthetic material such as epoxy, silicone, plastic or synthetic resin, is cured or cooled down, the mold 44 (not shown) is detached, and integral ballast assembly 48 is formed. The integral ballast assembly 48 has no casing, as the hardened heat-conductive compound 47 forms its entire outer surface that is above and connecting immediately to the month line 46a of the lamp base 46, and below this mouth line, the outer metallic surface of lamp base 46 becomes its own surface. The first ends (not shown) of the conducting wires 49a and 49b are connected electrically to the output ends (not shown) of the high-frequency and high-voltage electronic driver 45 (not shown) that is totally embedded within the heat-conductive compound 47. The remaining portion of conducting wires 49a and 49b extruding from the integral ballast assembly are for connection to the electrodes of the CCFL filament electrically.

Also referring to FIG. 11(b), the heat-conductive compound 47 that forms the integral ballast assembly 48 is serving as a thermal bridge between the components of the electronic driver 45 (not shown) and the lamp base 46. The lamp base 46 serves as a heat sink with the threads of its screws acting as fins allowing heat to dissipate directly to the lamp sockets and electricity mains, both of which have high copper/metal content and therefore have superior thermal conductivity. There is no insulating air trapped inside the electronic driver after it is integrally formed with the lamp base 46, the integral ballast assembly 48 therefore acts at an efficient heat radiating body, as a large portion of its surface is directly exposed to air.

Again referring to FIG. 11(b), the heat-conductive compound 47 also provides superior insulation and protection to the high-voltage transformers of the electronic driver 45 (not shown) embedded inside the integral ballast assembly 48, allowing it to extend its life span substantially. In providing the integral ballast assembly 48 according to the present invention, the electronic driver 45 (not shown) is placed at a further distance away from the CCFL electrodes than is in the case of being placed inside a housing attached to the light-transmitting container. This enables the electronic driver 45 (not shown) to operate with lower ambient temperature and therefore can have a longer operating life.

Another benefit of forming the integral ballast assembly by a detachable and water-tight mold 44 provides the flexibility of attaching different types of lamp bases, which can be of a conventional Edison lamp base, or other newer designs such as GU10, GU34, half-height screw base, etc. The lamp base can be placed inside the mold before the heat-conductive compound is filled in, or attached later after the integral ballast assembly is formed before connecting to the lamp base.

One other important benefit of forming the integral ballast assembly, according to the present invention, is that it eliminates the need of housing for the electronic driver. As explained before, said housing is undesirable as it causes the electronic driver to be easily overheated. Another benefit is to allow the electronic driver be fabricated in a multi-module format instead of a single piece, so that it can be placed flexibly to fill most of the space available within the mold and the lamp base. As there is no wall for the integral ballast assembly apart from the thin metallic cap of the lamp base, the overall size of the ballast assembly can be substantially reduced. This also reduces the amount of heat-conductive compound to be used, as well as the heat path of the electronic components to reach to the outer surface of the integral ballast assembly.

### EMBODIMENT 5

Another embodiment of the present invention provides a cost effective method to attach both the integral ballast assembly and the hermetically sealed lamp body to a container connection member by using bonding agent, which comprises silicone gel such as RTV, low melting point solder glass or other heat-enduring adhesives.

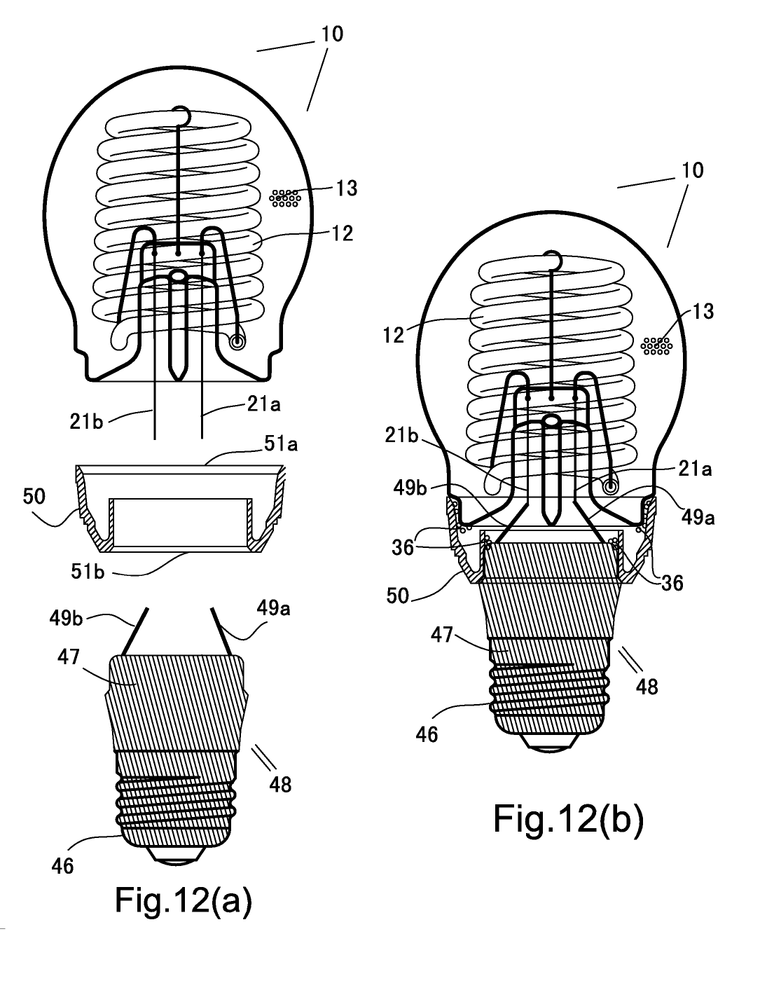

Referring to FIG. 12(a), it shows the three main sub-assemblies of the CCFL device according to the present invention, i.e., the lamp body 10, the container connection member 50, and the integral ballast assembly 48. The container connection member 50 is a structure of a pre-determined shape, with an inner surface on its first opening 51a that is similar in shape but slightly bigger than the outer surface of the bottom circumference of lamp body 10. The container connection member 50 also has an inner surface on its second opening 51b that is similar in shape but slightly bigger than the top of the integral ballast assembly that is pointing away from the lamp base 46.

Referring to FIG. 12(b), a fully assembled CCFL device according the present invention is made from the three main sub-assemblies of FIG. 12(a), in which the first opening 51a of container connection member 50 is attached to the bottom of the lamp body 10 by the bonding agent 36, which comprises silicone gel such as RTV, low melting point solder glass or other heat-enduring adhesives. The second opening 51b of container connection member 50 is also attached to the top of the integral ballast assembly 48 by same bonding agent 36. The pair of conducting wires 49a and 49b extruding from the integral ballast assembly 48 is electrically connected to the conducting wire 21a and 21b that are in turn electrically connected to the electrodes (not shown) of CCFL filament 12.

The container connection member 50 of the present invention is preferably formed of metal such as aluminum, although it can also be formed of other materials such as plastic, glass or ceramic. One major benefit of forming the integral ballast assembly 48 by the insulative heat-conductive compound 47 is to enable the container connection member 50 be formed of metal, as it is insulated from the metallic lamp base 46, otherwise, it must be made of plastic or ceramic, which are poor heat conductors.

With a metallic container connection member 50 connecting the light-transmitting container 10 and the integral ballast assembly 48, heat from the lower part of the CCFL filament, particularly from the electrodes, can be radiated and conducted swiftly to the atmosphere and by the surface of the metallic connection member, so lesser heat will be passed to the electronic driver. This reduces the temperature of the electronic driver and increases the useful life of the CCFL device. This arrangement is much better than separating the CCFL filament and the electronic driver by a conventional air-gap, which is difficult to assembly, causes the device to have an unpleasant outlook, and easily traps insets and dusts inside the gap.

By using the integral ballast assembly provided by this embodiment of the present invention, the improved CCFL device can be assembled cost effectively, as only two final assembly steps are involved, i.e., connecting the electrodes of CCFL filament to the electrical outputting conductors of integral ballast assembly, and attaching the light-transmitting container with the integral ballast assembly by the container connection member. Moreover, the production of the lamp body comprising the light-transmitting container and the lamp filament, as well as the forming of the integral ballast assembly can be produced separately by specialty factories and/or sub-contractors.

### EMBODIMENT 6

Another embodiment of the present invention is similar to Embodiment 5 above, except that, the container connection member is affixed integrally with integral ballast assembly when the latter is formed by using the heat-conductive compound filling the space between the electronic driver and the lamp base air-tightly. This is done by using a mold similar but bigger than mold 44 of FIG. 11(a), so that the container connection member, the lamp base and the electronic driver are securely placed inside the mold before the heat-conductive compound is filled in. Using this method, the mold for forming the integral ballast assembly is more complicated, but it eliminates the step of gluing the container connection member to the integral ballast assembly during the final lamp assembly.

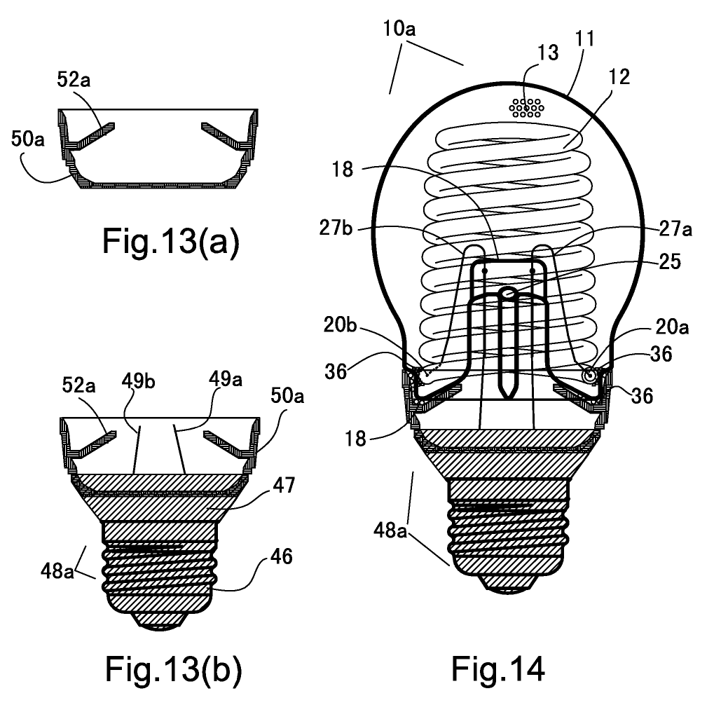

Referring to FIG. 13(a), the container connection member 50a has an container support member 52a inside that is tilted upward, so that it can support lamp bodies such as those of 10, 10a, 10b, 10c and 10d and 10e of FIG. 2, FIG. 3(b), FIG. 4(b), FIG. 5(b), FIG. 6(b) and FIG. 7(b), respectively, which use lamp foot 18 to connect to the lamp filament support member(s) and to form the hermetical seal with the light-transmitting container 11. Referring FIG. 13(b), the integral ballast assembly 48a is formed integrally with the container connection member 50a.

Referring to FIG. 14, the CCFL device is formed from lamp body 10a which has the arc-type legs of its CCFL filament 12 bonded to the inner surface of the bottom portion of the light transmitting container 11. The lamp body 10a is attached to the ballast assembly 48a of FIG. 13(b) using bonding agent 36, which comprises silicone gel such as RTV, low melting point solder glass or other heat-enduring adhesives.

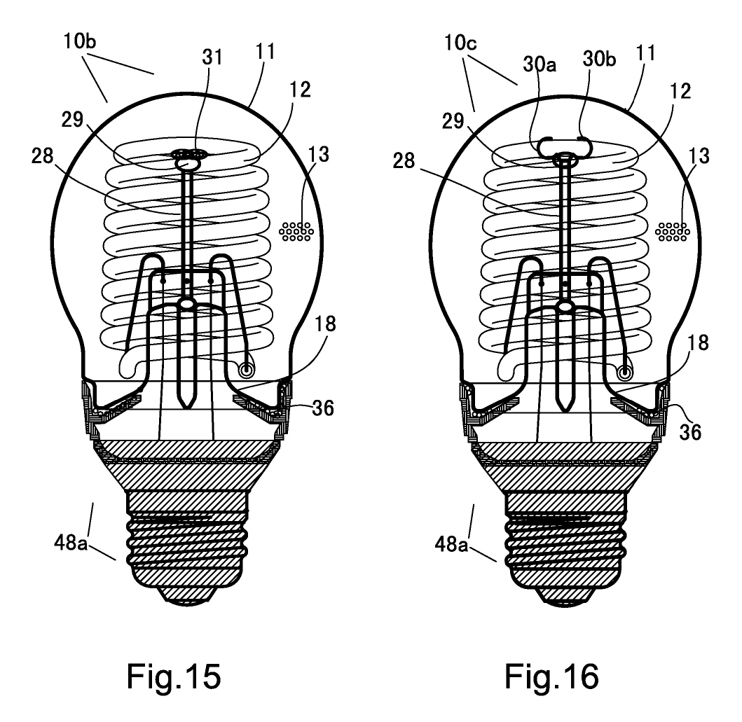

Referring to FIG. 15 and FIG. 16, the CCFL devices have their lamp bodies 10b and 10c using different lamp support members 28 and 29 similar to those of FIG. 4(b) and FIG. 5(b), respectively, and their respective lamp bodies 10b and 10c are attached to the integral ballast assembly 48a using bonding agent 36.

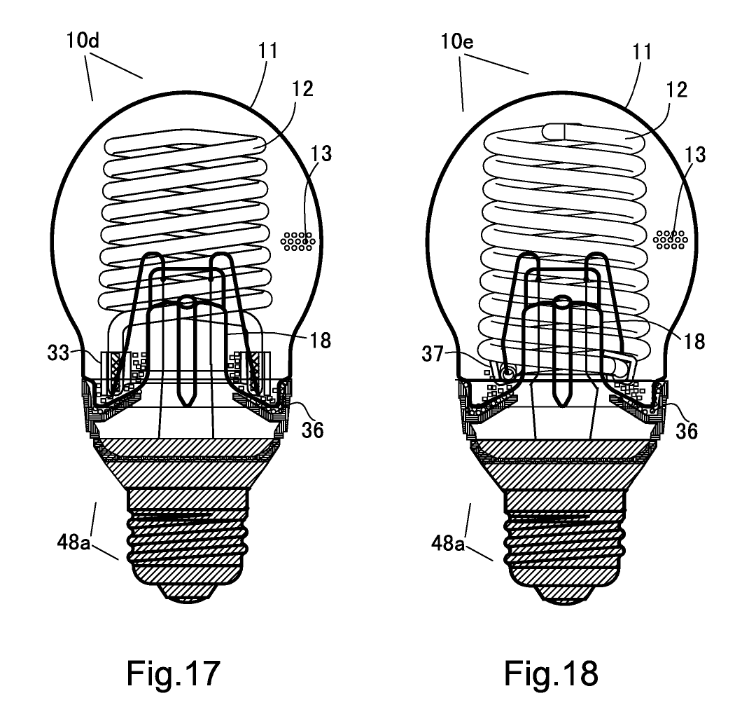

Referring to FIG. 17 and FIG. 18, the CCFL devices use the same integral ballast 48a of FIG. 13(b), and their lamp bodies 10d and 10e are same as those of FIG.6(b) and FIG. 7(b) respectively, in which the CCFL filament 12 is attached to lamp filament support members 33 and 38, respectively. The respective lamp bodies 10d and 10e are attached to the integral ballast assembly 48a using bonding agent 36.

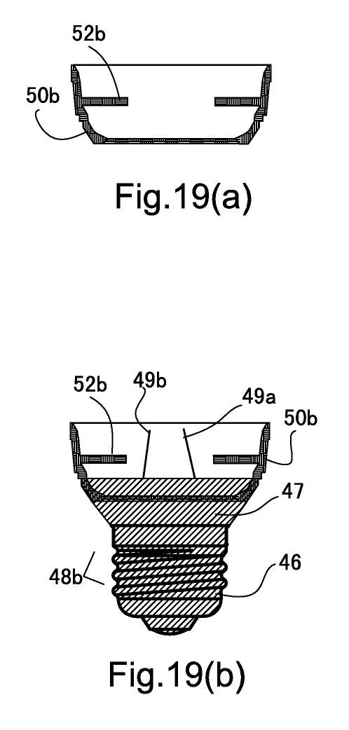

Referring to FIG. 19(a), the container connection member 50b is of similar size to container connection member 50a of FIG. 13(a), but its container support member 52c is flat and horizontally placed. Referring to FIG. 19(b), the integral ballast assembly 48b is integrally formed together with the container connection member 50b of FIG. 19(a), and it is for attaching to lamp bodies with a flat bottom such as lamp bodies 10f, 10g, 10h and 10i of FIG. 8(b), FIG. 9(b), FIG. 10(a) and FIG. 10(b), respectively.

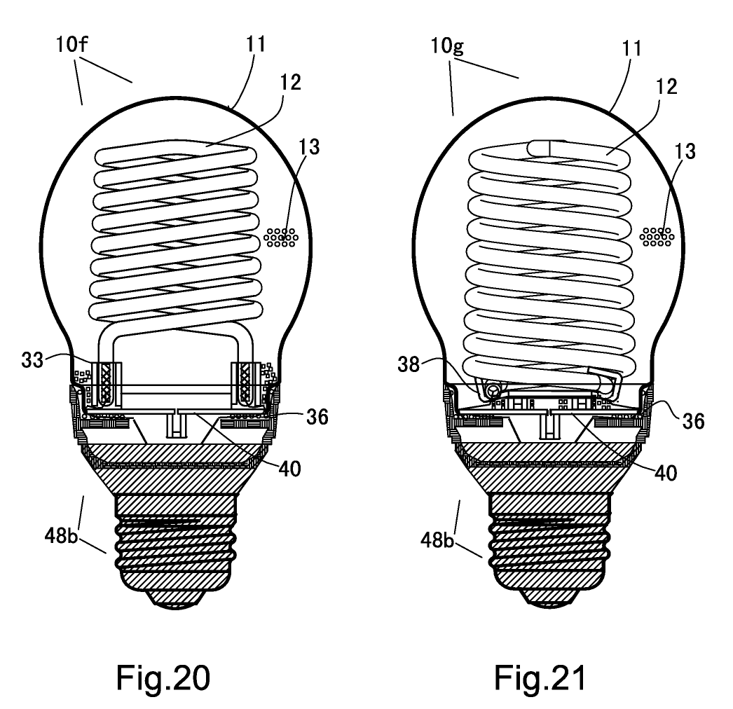

Referring to FIG. 20 and FIG. 21, they represent two fully assembled CCFL devices, both of which use the integral ballast assembly 48b similar to the one of FIG. 19(b), and they have their lamp bodies 10f and 10g similar to those of FIG. 8(b) and FIG. 9(b) respectively, in which no lamp foot is used, and the CCFL filament 12 is attached to lamp filament support members 33 and 38, respectively, and the light-transmitting container 11 is hermetically sealed to the base plate 40.

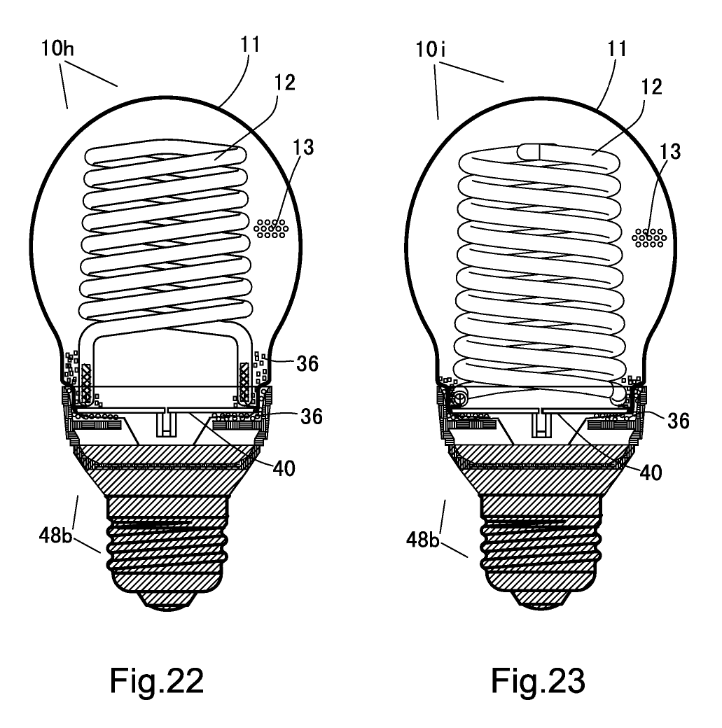

Referring to FIG. 22 and FIG. 23, they represent another two fully assembled CCFL devices, both of which use the integral ballast assembly 48b similar to the one of FIG. 19(b), and they have their lamp bodies 10h and 10i same as those of FIG. 10(a) and FIG. 10(b) respectively, in which no lamp foot and lamp filament support member are used, but the legs of CCFL filament 12 are attached to inner surface near the bottom of the light-transmitting container 11 by using bonding agent 36, and the light-transmitting container 11 is hermetically sealed to the base plate 40.

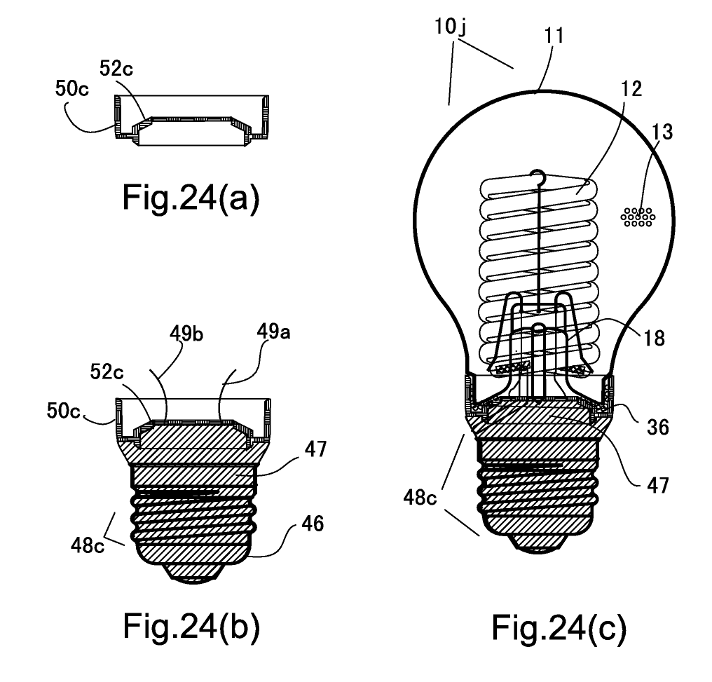

Referring to FIG. 24(a), the container connection member 50c is smaller than container connection member 50a of FIG. 13(a), and it has a tilted container support member 52c. Referring to FIG. 24(b), the integral ballast assembly 48c is integrally formed together with the container connection member 50c of FIG. 24(a).

Referring to FIG. 24(c), the CCFL device uses the integral ballast 48c similar to the one of FIG. 24(b). It is attached to a smaller lamp body 10j housing a smaller CCFL filament 12 affixed within the light-transmitting container 11 by lamp foot 18 in a similar manner as forming the lamp body 10 of FIG.2. The lamp body 10j here is attached to the integral ballast assembly 48c using bonding agent 36.

### EMBODIMENT 7

Another embodiment of the present invention is similar to Embodiment 6 above, except that, the container connection member is also formed of the same heat-conductive compound that is used to form the entire integral ballast assembly. As such, there is no need to fabricate a separate container connection member using metal or other materials. The integral ballast assembly formed in this manner has its own container connecting opening for attachment to the bottom of the light-transmitting container by bonding agent such as a silicone adhesive, a low melting point solder glass or other heat-enduring adhesives.

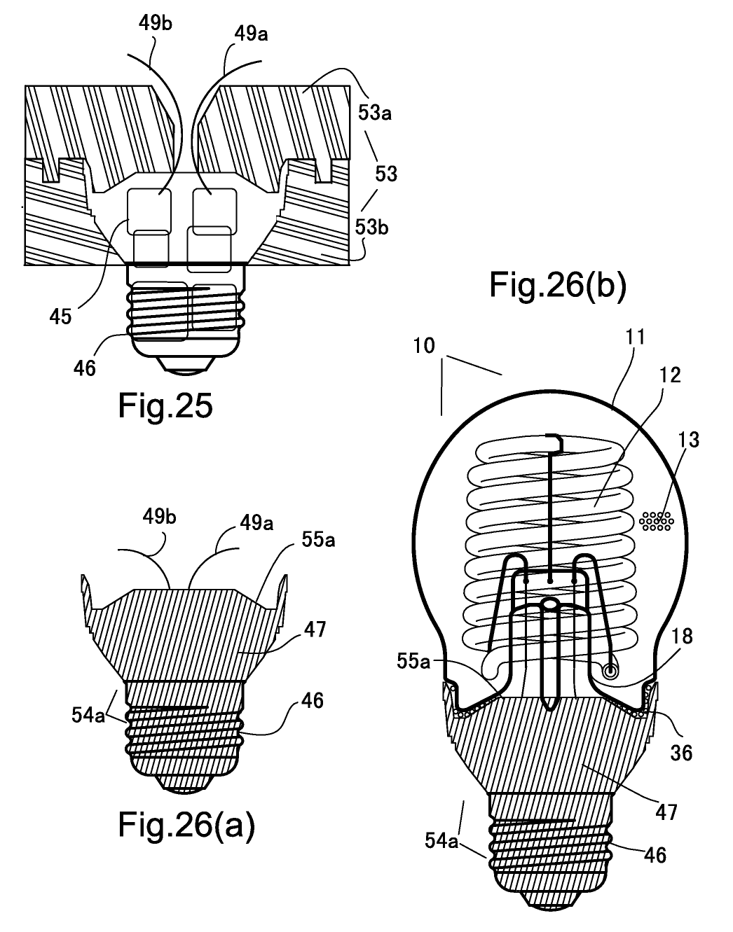

Referring to FIG. 25, the various modules of the electronic driver 45 are electrically connected to the lamp base 46 before they are disposed inside a two part mold 53 that has an upper mold 53a and a lower mold 53b. Then the heat-conductive compound 47 (not shown) is filled in by hand or by a vertical injection machine.

Referring to FIG. 26(a), the integral assembly 54a with its own container connection opening 55a is detached from mold 54 (not shown) after the heat-conductive compound 47 is cured or cooled down. The entire surface of integral assembly 54a, apart from the portion covered by the lamp base 46, is formed from the heat-conductive compound 47 that embeds the electronic driver 45 (not shown) inside. As is pre-determined by the mold 53, integral ballast assembly 54a has the same shape as the integral ballast assembly 48a of FIG. 13(b). The electrical connectors 49a and 49b are electrically connected to the output side of the embedded electronic driver 45 (not shown), and the portion of them extruding from the top of integral ballast assembly 48a are for connection to the electrodes of the CCFL filament during final lamp assembly.

Referring to FIG. 26(b), the fully assembled CCFL devices are formed from the integral ballast assembly 54a of FIG. 26(a), which is attached to the bottom of the lamp body 10 that fits to their container connection openings 55a,by bonding agent 36.

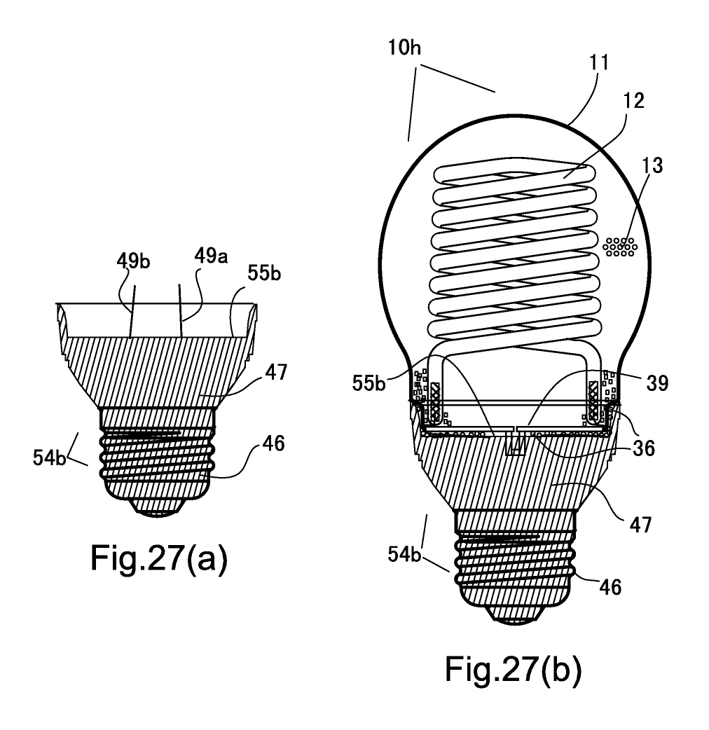

Referring to FIG. 27(a), the integral assembly 54b is similar in shape and functionality with the integral ballast assembly 48b of FIG. 19(b), but has a different container connection opening 55b formed from the heat-conductive compound 47.

Referring to FIG. 27(b), the fully assembled CCFL device is formed from the integral ballast assemblies 54b FIG. 27(a), which are attached to the bottom of lamp body 10h that fits to its container connection openings 55b, by using bonding agent 36.

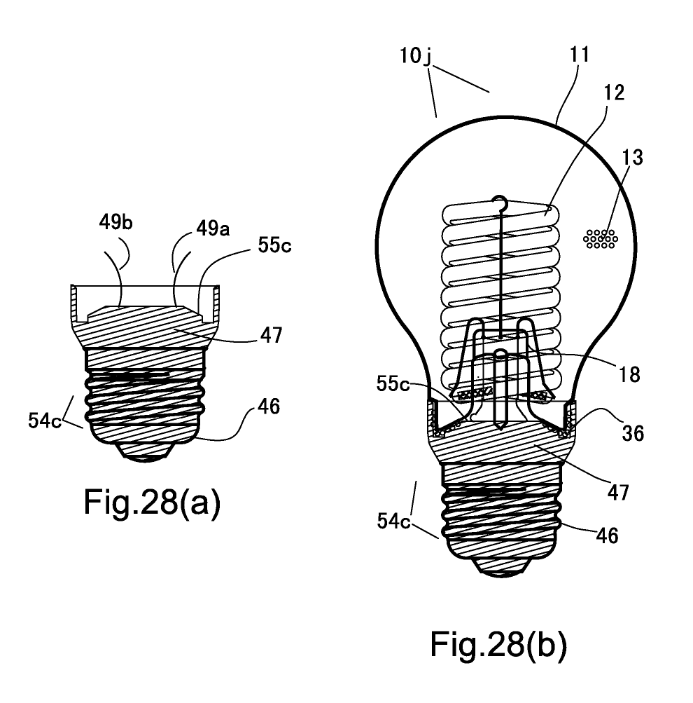

Referring to FIG. 28(a), the integral assembly 54c is similar in shape and functionality with the integral ballast assembly 48c of FIG. 24(b), but it has its container connection openings 55c formed from the heat-conductive compound 47.

Referring to FIG. 28(b), the fully assembled CCFL device is formed from the integral ballast assemblies 54c of FIG. 28(a), which is attached to the bottom of the lamp bodies 10j, that fits to its container connection opening 55c, by using bonding agent 36.

### EMBODIMENT 8

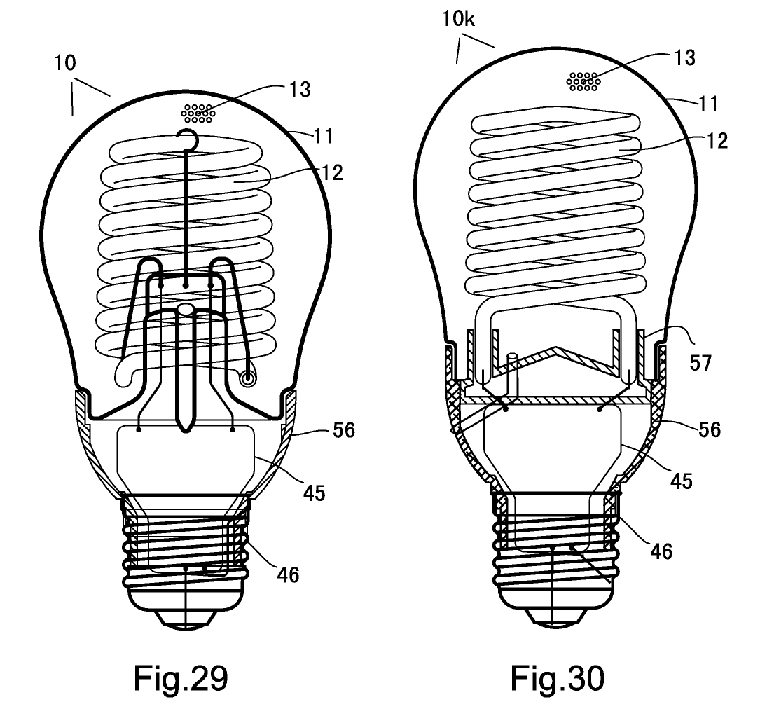

Another embodiment of the present invention provides am improvement to certain conventional CCFL devices so that these also benefit from the novel heat dissipation means of the present invention. As such, a high thermal conductivity gas is filled within the light-transmitting container in order to improve the light output efficiency of the CCFL device. Such a conventional CCFL device usually has a housing for the driver that connects to the light transmitting container, and it has a first opening adjacent to the container and a second opening adjacent to the lamp base, where the first opening has a larger dimension than the second opening, as referring to the devices of FIG. 29 and FIG. 39.

Referring to FIG. 29, the CCFL device has a housing 56 for the electronic driver 45, and the housing 56 is attached to the light-transmitting container 11 of lamp body 10.

Referring to FIG. 30, the CCFL device has a lamp filament support member 57 connected to light transmitting container 11 of lamp body 10k,as well as to housing 56 for the electronic driver 45, and the housing is also attached to the light-transmitting container 11.

Both devices referring to in FIG. 29 and FIG. 30 are more difficult to assemble than those of the previous embodiments of the present invention. However, filling the high thermal conductivity gas 13 within the light-transmitting container 11 can still help to it to improve its light output efficiency by about 20%.

### EMBODIMENT 9

There are wide applications of the HCFL plug-in lamps commonly known as the PLs (brand name of Philips), Biax (brand name of GE) and Dulux (brand name of Osram), that are usually of 1U, 2U, 4U, 6U shapes and etc, and uses the G23, G24 or G24d bi-pin or quad-pin electrical connectors. On the other hand, the HCFL T5, T8, T9 and T12 tubular lamps with G5, G13 or R17d electrical connectors are also commonly used in positions such as ceilings and lamp posts that are difficult to reach. The short life span of the HCFL is causing big problem owing to their frequent replacement needs, as their positions are normally difficult to reach. Moreover, these HCFL devices are not dimmable by ordinary wall dimmers. As such, it is highly desirable to have a long-life and dimmable alternatives provided by the CCFL T5, T8, T9 and T12 tubular lamps with G5, G13 or R17d electrical connectors, and the CCFL plug-in lamps using the G23, G24 or G24d bi-pin or quad-pin electrical connectors.

As these devices are usually for areas where high luminous intensity is required, so they must be able to operate under high electricity input power. As such, it is desirable to fill a high thermal conductivity gas within their light transmitting containers, so that they can generate optimum light output compatible to their HCFL counterparts when operating with high electricity input power.

The CCFL plug-in lamps with G23, G24 or G24d electrical connectors, according to the present invention, have at least one CCFL filament coiled into spiral or multi-U shape, housing inside a tubular light-transmitting container attaching with the G23, G24 or G24d electrical connectors. As the novel CCFL plug-in lamps are aiming for high electricity power input, their light-transmitting containers are hermetically sealed with a high thermal conductivity gas inside.

For the plug-in lamps, their electrical connectors are always big enough to house part of the electronic driver. As such, the high-voltage transformer, being the output component of the full electronic driver, can be placed inside the electrical connector, together with a fuse and other components necessary for the high-voltage transformer to generate high-voltage electricity after receiving the low voltage high-frequency electricity from the remaining part of the full electronic driver that is located externally. In this way, low voltage electricity can pass safely through a longer distance between the partial driver and the electrical connector of the CCFL device.

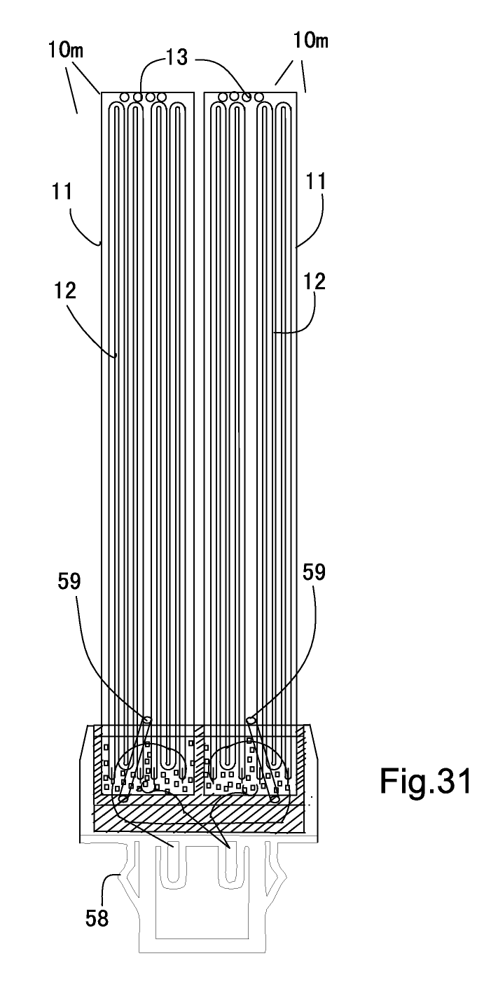

Referring to FIG. 31, a plug-in lamp with a 4-pin electrical connector 58 attached to two tubular lamp bodies 10 m, has a multi-U CCFL filament 12 inside each of the tubular light-transmitting containers 11 that are hermetically sealed with a high thermal conductivity gas 13 inside. For these devices, a partial electronic driver (not shown) comprising a high-voltage transformer and a few associated passive components as well as a fuse, may also be housed inside the electrical connector 58. In each lamp body 10 m, an exhaust tube 59 is used to excavate air from the light transmitting container 11 and to fill in the high thermal conductivity gas 13.

On the other hand, The CCFL tubular lamps with G5, G13 or R17d electrical connectors, according to the present invention, contains at least one elongated CCFL filament that is bent into to 1-U, 2-U, 3U or multi-U shaped linear forms, housing inside the light-transmitting containers of T5, T8, T9 or T12 shapes that is filled with a high thermal conductivity gas inside. The elongated CCFL filament can also be a linear one without any U or other bending.

As the tubular CCFL devices above use external electronic drivers that are detached from the device by a considerable length, and it is undesirable to transfer high-voltage electricity of 500-2,500 volts over such long distance. As such, it would be most desirable to have the electronic driver positioned as close to their electrodes as possible.

For the CCFL tubular lamps, they always have a large fixture holding the lamp as well as for housing the electronic driver. Conventional CCFL tubular design uses the same format of the HCFL that electricity are supplied from both ends of the tubular filament, but this should be avoided, as it is dangerous to transfer high-voltage electricity of 500-2,500 volts over long distances within the fixture.

Fortunately, each electrical connector of such tubular devices have two bi-pin electrical connectors, which must be either the standards G5 and G13 electrical connectors that are attached to both ends of the tubular device. As such, the electrodes can be electrically coupled in such a way the only one bi-pin connector at one end is used for electricity connection, leaving the other one have neither of its two pins electrically coupled to the electrodes of the CCFL filament, and is only used for attaching to the electrical sockets for supporting the lamp mechanically.

In this manner, according to the present invention, the electrical connections for the electrodes to the pins for the electrical connectors of the CCFL T5, T8, T9 or T12 tubular lamps with G5, G13 or R17d connectors are carefully designed so that the external electronic driver is positioned close to only one end of the tubular CCFL devices and supplies electricity to the device through both pins of only one selected 2-pin electrical connector. This novel arrangement for the electrodes and the electrical connector, as no prior art has ever taught, is not limited to CCFL devices of the present invention that has a high thermal conductivity gas filled inside the light transmitting container, but also extend to include those which do not have such high thermal conductivity gas filled inside the light transmitting container.

For the sake of providing the novel CCFL device of the present invention for those prefer conventional style of connecting tubular lamps by placing the ballast mid-way between both ends of the tubular device, the CCFL T5, T8, T9 or T12 tubular lamp of this invention that are having a plurality of G5, G13, or R17d bi-pin electrical connector, and a high thermal conductivity gas filled inside the light transmitting container, may also have their electrodes so connected that external electricity is supplied to one or both pins on each bi-pin electrical connectors at both ends of the tubular device.

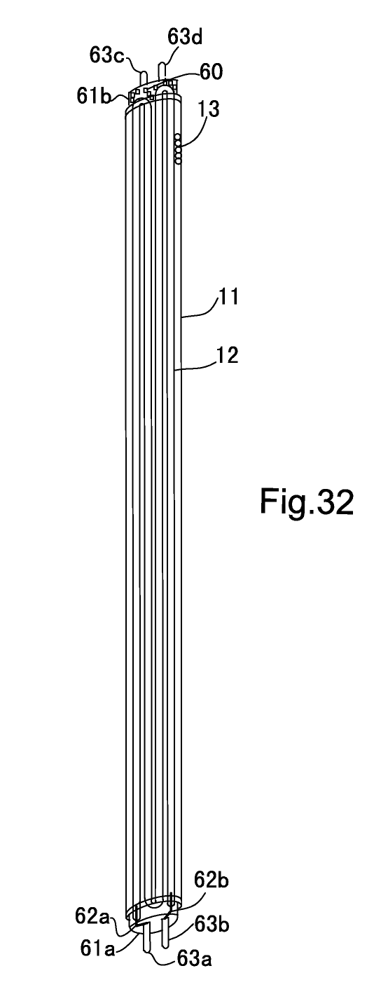

Referring to FIG. 32, a CCFL T8 tubular device is shown with a 3-U linear CCFL filament 12 housing inside the T8 light-transmitting container 11, which is hermetically sealed with bonding agent 60 and contains a high thermal conductivity gas 13 inside. It has two bi-pin electrical connectors 61a and 61b on each side. However, the conducting wires 62a and 62b connecting from the electrodes (not shown) of the CCFL filament 12 are residing on one side of the device, and they are connected to the two pins 63a and 63b of the same bi-pin electrical connector 61a. The other two pins 63c and 63d of the electrical connector 61b are therefore not used to connect to the electrodes of the CCFL filament 12.

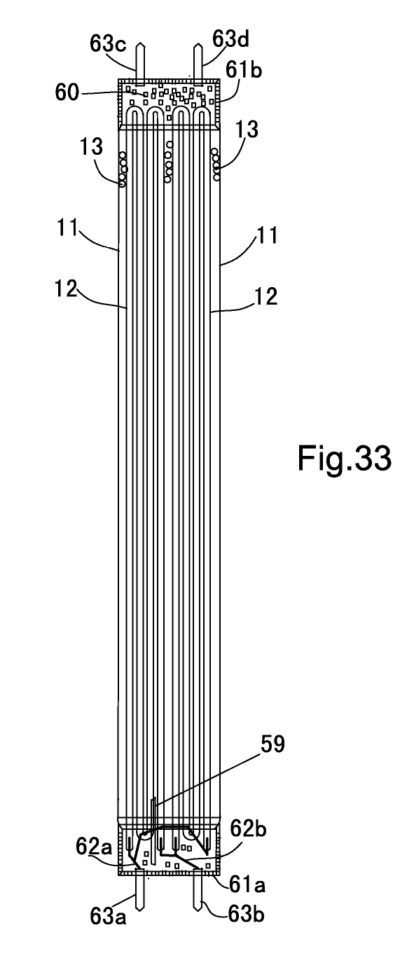

Referring to FIG. 33, it is almost the same device as that of FIG. 32, except that it is of T12 size and has two 3-U linear filaments 12 housing inside the T12 light-transmitting container 11, which is hermetically sealed with bonding agent 60 and contains a high thermal conductivity gas 13 inside. The exhaust tube 59 at one side of the device is used to excavate air from, and to fill the high thermal conductivity gas 13 inside the light-transmitting container 11. Again, same as the device of FIG. 21, only the pins 63a and 63b of the same bi-pin electrical connector 61a is used to conduct electricity through conducting wires 62a and 62b connected to the respective electrodes of the both CCFL filament 12, and the other bi-pin electrical connector 61b is used only for attaching to the conventional power sockets in order to support the CCFL device firmly inside the appropriate lamp fixture.

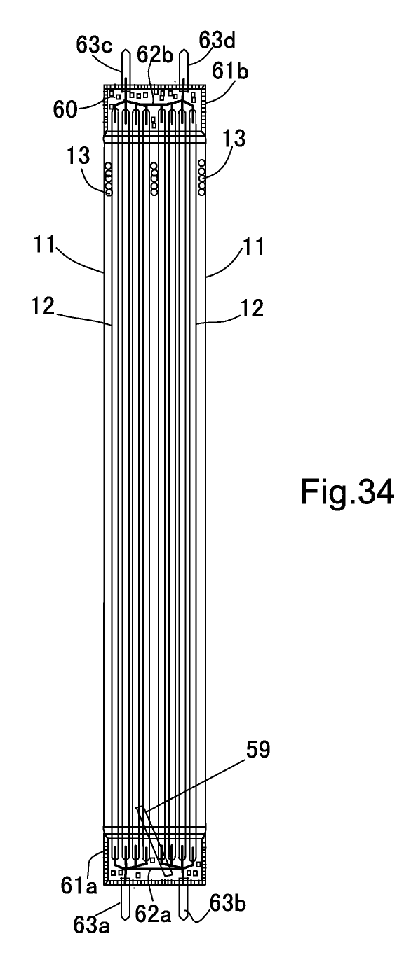

Referring to FIG. 34, it is same device as that of FIG. 23, but six linear CCFL filaments 12 are housing inside the T12 light-transmitting container 11, which is hermetically sealed with bonding agent 60 and contains a high thermal conductivity gas 13 inside. The exhaust tube 59 at one side of the device is used to excavate air from, and to fill the high thermal conductivity gas 13 inside the light-transmitting container. In this device, the plurality of electrodes on each side are connected together by conducting wires 62a and 62b, respectively, which are connected to the pins of the electrical connectors in such a manner: wire 62a is connected to one (or both) of pins 63a and 63b of bi-pin connector 61a, and wire 62b is connected to one (or both) of pins 63c and 63d of bi-pin connector 61b. As such, both electrical connectors 61a and 61b are connected to the external electronic driver (not shown) for the CCFL device, which is less convenient as the electronic driver has to be positioned in near the middle of the tubular device. However, this mode of electrical connection may be preferred by those who opt for connecting the tubular devices in the conventional HCFL style, i.e., putting the ballast at the middle of the fixture.

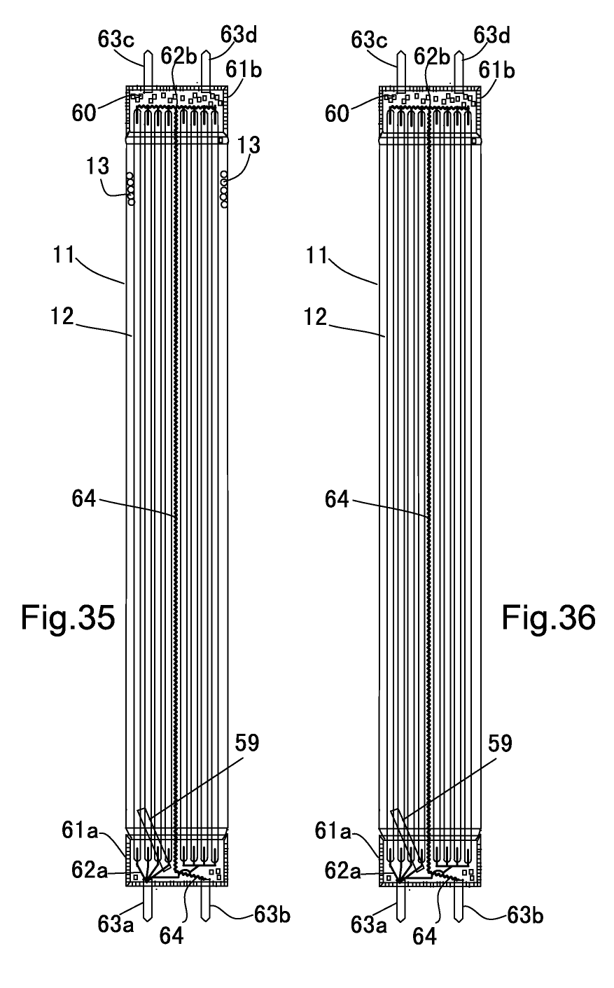

Referring to FIG. 35, it is same device as that of FIG. 34, also with six linear CCFL filaments 12 are housing inside the T12 light-transmitting container 11, which is hermetically sealed and contains a high thermal conductivity gas 13 inside. In this device, the plurality of electrodes on each side are connected together by conducting wires 62a and 62b, which are connected to the pins of the electrical connectors in such a manner: wire 62a is connected to one pin 63a of bi-pin connector 61a, and wire 62b is connected via a long conducting wire 64 running through the entire length of the light-transmitting container 11 so that it is connected to pin 63b of the bi-pin connector 61a on the opposite side. As such, only electrical connector 61a is connected to the external electronic driver (not shown), which is more convenient, as the electronic driver can be placed close to the electrodes instead of at the middle of tubular container.

Referring to FIG. 36, it is the same device as that of FIG. 35, except that there is no high thermal conductivity gas filled inside the light transmitting container 11. Same as the device of FIG. 35, only electrical connectors 61a is connected to the external electronic driver (not shown) for the CCFL device, which is more convenient, as the electronic driver can be placed more flexibility instead of at the middle of tubular container 11.

The CCFL plug-in, T5, T8, T9 and T12 lamps according to the present invention normally has multiple CCFL filaments inside the light-transmitting containers, and they can be of different colors on their own. As such, by using a variable color circuitry with a specially designed color switching CCFL electronic driver, the said lamp tube can produce any desirable color in any pre-determined color effects.

While the invention has been described above by reference to various embodiments, this should not be construed as a limitation on the scope of the present invention. It will be understood that changes and modifications may be made without departing from the scope of the invention, and many other variations and modifications and other uses will become apparent to those skilled in the art. Therefore, the present invention should be limited not by the specific disclosure herein, but rather by the appended claims and their legal equivalents.

1. A cold cathode fluorescent lamp device comprising:
at least one cold cathode fluorescent lamp with at least one electrode;
a light-transmitting container that is hermetically sealed and housing said at least one lamp; and
a gas fill of thermal conductivity better than air enclosed inside said light-transmitting container.

2. The device of claim 1, wherein
said gas fill comprises a hydrogen, helium or neon gas, or a mixture with at least one of the helium, hydrogen and neon gases.

3. The device of claim 1, further comprising:
an electronic driver that is connected electrically to said at least one electrode of said at least one lamp; and
at least one a lamp base or electrical connector for mechanical and electrical connection to a power outlet or an electrical socket, thereby supplying either AC or DC power to said electronic driver.

4. The device of claim 3, further comprising:
an assembly of heat-conductive compound comprising a synthetic material, embedding at least one portion of said electronic driver and filling the space between said electronic driver and said lamp base.

5. The device of claim 4, wherein
said assembly of heat-conductive compound forms a surface connecting immediately to the lamp base; and
a portion of said surface connecting immediately to the lamp base is exposed to air.

6. The device of claim 4, further comprising:
a bonding agent comprising a silicone adhesive, a low melting point solder glass or other heat enduring adhesives attaching said assembly of heat-conductive compound to said light-transmitting container.

7. The device of claim 4, further comprising:
a container connection member that has a first opening attached to said light-transmitting container, and has a second opening attached to said assembly of heat-conductive compound.

8. The device of claim 3, further comprising:
a housing for said electronic driver, said housing connecting said light-transmitting container, said housing having a first opening adjacent to said light-transmitting container and a second opening adjacent to said lamp base, and said first opening having larger dimensions than the second opening.

9. The device of claim 1, further comprising:
at least one lamp filament support member supporting said at least one lamp and connecting to said light-transmitting container.

10. The device of claim 1, further comprising:
a lamp foot comprising an exhaust tube, a circular flange with an edge and at least two metallic members each connected to a conducting wire, wherein each of said at least two metallic members is connected to at least one electrode of said at least one lamp, and the edge of said circular flange is sealed hermetically with said light-transmitting container.

11. The device of claim 1, further comprising:
a base plate with an exhaust tube on its surface, wherein the edge of said base plate is sealed hermetically with the bottom of said light-transmitting container.

12. The device of claim 11, further comprising:
at least one lamp filament support member supporting said at least one lamp and connecting to said base plate.

13. The device of claim 1, wherein
said at least one lamp has a linear shape, a spiral shape, a double-spiral shape, or a multi-U shape with at least one U-shape bending; and
said light-transmitting container has an A shape, a pear shape, a candelabra shape, a globe shape, a cylindrical shape, a cone shape, a MR16 shape, a MR103 shape, or any other shapes commonly taken on by an ordinary incandescent light bulb; the material used to form said light-transmitting container can be glass, plastic, resin or metal, or a combination of these different materials; and said light-transmitting container may or may not be coated with a reflective inner surface.

14. The device of claim 1, further comprising:
at least one lamp base or electrical connector mechanically coupled to said light-transmitting container; wherein said at least one lamp base or electrical connector is a bi-pin or quad-pin electrical connector comprising the G23, G24, G24d or other conventional electrical connectors for the plug-in lamps, or is a bi-pin electrical connector comprising the G3, G13, R17d or other conventional electrical connectors for the tubular fluorescent lamps; or is a conventional screw type, prong type, GU-10, GU34, GX106 or other conventional lamp base for the ordinary incandescent lamps; and wherein at least one portion of said at least one lamp base or electrical connector is electrically connected to said at least one electrode of said at least one lamp.

15. A cold cathode fluorescent lamp device comprising:
at least one cold cathode fluorescent lamp with at least one electrode;
a light-transmitting container housing said at least one lamp;
a bonding agent attaching said at least one lamp to the inner surface of said light-transmitting container, wherein said bonding agent comprising a low melting point solder glass, epoxy, RTV silicone or other adhesives;
an electronic driver that is connected electrically to said at least one electrode of said at least one lamp; and
at least one a lamp base or electrical connector for mechanical and electrical connection to a power outlet or an electrical socket, thereby supplying either AC or DC power to said electronic driver.

16. The device of claim 15, wherein said light-transmitting container is hermetically sealed, and further comprising:
a gas fill of thermal conductivity better than air enclosed inside said light-transmitting container.

17. The device of claim 15, further comprising:
an assembly of heat-conductive compound comprising a synthetic material, embedding at least one portion of said electronic driver and filling the space between said electronic driver and said lamp base.

18. The device of claim 17, further comprising:
a container connection member that has a first opening attached to said light-transmitting container, and has a second opening attached to said assembly of heat-conductive compound.

19. The device of claim 16, further comprising:
a lamp foot comprising an exhaust tube, a circular flange with an edge and at least two metallic wire, wherein each of said at least two metallic rode of said at least one lamp, and the edge of said said light-transmitting container.

20. The device of claim 16 further comprising:
a base plate with an exhaust tube on its surface, wherein the edge of said base plate is sealed hermetically with the bottom of said light-transmitting container.
